(19) United States
(12) Patent Application Publication
(10) Pub. No.: US 2025/0032338 A1
(43) Pub. Date: Jan. 30, 2025

(54) SPINAL MASSAGE DEVICE

(71) Applicant: Pacla Medical Limited, Edinburgh, Lothian (GB)

(72) Inventors: Chongsu LEE, Edinburgh (GB); Marco MIGLIONICO, Edinburgh (GB)

(21) Appl. No.: 18/427,743

(22) Filed: Jan. 30, 2024

(30) Foreign Application Priority Data
Jul. 26, 2023 (GB) 2311496.0

(51) Int. Cl. A61H 1/02; A61H 15/00

(52) U.S. Cl. CPC A61H 1/0292; A61H 15/0078; A61H 2015/0007; A61H 2201/1607; A61H 2203/0456

(57) ABSTRACT

A spinal massage device comprises first to fifth manipulating assemblies of pairs of opposed manipulating members, each manipulating member having a generally rounded contact area and a set of actuators to move the manipulating members progressively controllably into or away from engagement with a user's back, whereby movement of the manipulating members of the second manipulating assembly includes a generally arcuate movement; a controller including logic is arranged to control the respective sets of actuators to move the manipulating members into contact with a user's back, select a massage routine and control the actuators to carry out the massage routine based on generally reciprocal motion; the controller being arranged to control the manipulating members within each of the fourth and fifth manipulating assemblies to move independently to create differential pressure, and being arranged to monitor and adjust contact pressures applied by the manipulating members.

### TECHNICAL FIELD

The present invention belongs to the field of back massage for mitigating symptoms of back pain, tension and stiffness.

### BACKGROUND

Human massage for treating back problems has been around for Millenia: massage relieves the symptoms of stiffness and tension in the back. However human massage is tiring for the treating person and cumbersome to arrange. Some attempts to mechanise this have been tried.

A problem with treating backs by massage is that individual backs vary in individual curvature and size. Some mechanical solutions address this by providing a device which treats only a portion of the back and moves along the back. However, this is time-consuming and the present inventors consider that it is less effective than treating an extended portion of a back simultaneously.

An earlier related application WO 2020/317059 A1 treats an extended portion of a user's back simultaneously and has received very favourable feedback from users in terms of improved outcomes rapidly; it has been described as revolutionary. However, pursuant to the invention, it has been found that yet further improvement is possible.

The contents of earlier related applications, published as WO 2017/168140 A1 and WO 2020/317059 A1, are incorporated herein by reference.

### DISCLOSURE OF INVENTION

Aspects of the invention are set out in the independent claims and preferred features are set out in the dependent claims.

According to a first aspect of the present invention there is provided a spinal massage device comprising:
a bed area arranged in use for a user to lie in a substantially horizontal supine position, the bed area defining a longitudinal axis arranged to lie substantially along a user's spine and extending in a longitudinal direction from a head region to a bottom region of the bed area, the bed area having opposed side regions each extending outwards in a lateral direction from the longitudinal axis, wherein a vertical direction is substantially perpendicular to the lateral direction and extends into and out of the bed area;
a head support area provided at the head region of the bed area and arranged in use to support at least a portion of the weight of a user's head when lying face-upwards on the bed area;
a movable leg support provided at the bottom region of the bed area and arranged in use to raise to an elevated position to support a user's legs at a level above the level of the bed area and to lower for storage or access,
a first manipulating assembly comprising at least a first pair of opposed manipulating members substantially symmetrically disposed about the longitudinal axis, each manipulating member having a generally rounded first contact area in use and having a first set of actuators configured to move the manipulating members of the first manipulating assembly progressively controllably into or away from engagement with the cervical region of a user's spine which movement includes at least a final substantially linear reciprocal translation movement whereby during at least a portion of the movement the first contact areas of the pair of opposed manipulating members move closer together as the pair of opposed manipulating members are raised;
a second manipulating assembly comprising at least a second pair of opposed manipulating members substantially symmetrically disposed about the longitudinal axis, each manipulating member having a generally rounded second contact area in use and having a second set of actuators configured to move the manipulating members of the second manipulating assembly progressively controllably into or away from engagement with a user's shoulder blade area which movement includes at least a portion of generally arcuate movement of each second contact area in a lateral direction as the opposed manipulating members are raised;
a third manipulating assembly comprising at least two third pairs of opposed manipulating members substantially symmetrically disposed about the longitudinal axis, each manipulating member having a generally rounded third contact area in use and having a third set of actuators configured to move the manipulating members of the third manipulating assembly progressively controllably into or away from engagement with the thoracic region of a user's spine which movement includes at least a final substantially linear reciprocal translation movement whereby during at least a portion of the movement the third contact areas of each pair of the opposed manipulating members move closer together as the pair of opposed manipulating members are raised and wherein the manipulating members of the third manipulating assembly are positioned laterally inside the manipulating members of the second manipulating assembly;
a fourth manipulating assembly comprising at least three fourth pairs of opposed manipulating members substantially symmetrically disposed about the longitudinal axis, each manipulating member having a generally rounded fourth contact area in use and having a fourth set of actuators configured to move the manipulating members of the fourth manipulating assembly progressively controllably into or away from engagement with the thoracic region of a user's spine which movement includes at least a final substantially linear reciprocal translation movement whereby during at least a portion of the movement the fourth contact areas of each pair of the opposed manipulating members move closer together as the pair of opposed manipulating members are raised;
a fifth manipulating assembly comprising at least four fifth pairs of opposed manipulating members substantially symmetrically disposed about the longitudinal axis, each manipulating member having a generally rounded fifth contact area in use and having a fifth set of actuators configured to move the manipulating members of the fifth manipulating assembly progressively controllably into or away from engagement with the lumbar region of a user's spine which movement includes at least a final substantially linear reciprocal translation movement whereby during at least a portion of the movement the fifth contact areas of each pair of the opposed manipulating members move closer together as the pair of opposed manipulating members are raised;
a controller including logic arranged to perform the following steps:—
(a) to receive a signal to indicate that a user is lying on the bed area with the movable leg support in the elevated position;
(b) to perform an initial user adaption phase wherein the manipulating members are raised by generally moving predominantly unidirectionally from a rest condition to protrude further from the bed area comprising:—
   a. controlling the first set of actuators to move the manipulating members of the first manipulating assembly into contact with the cervical region of a user's spine with a contact pressure within a first contact pressure range;
   b. controlling the second set of actuators to move the manipulating members of the second manipulating assembly into contact with a user's shoulder blade area with a contact pressure within a second contact pressure range;
   c. controlling the third set of actuators to move the manipulating members of the third manipulating assembly into contact with the thoracic region of a user's spine with a contact pressure within a third contact pressure range;
   d. controlling the fourth set of actuators to move the manipulating members of the fourth manipulating assembly into contact with the thoracic region of a user's spine with a contact pressure within a fourth contact pressure range;
   e. controlling the fifth set of actuators to move the manipulating members of the fifth manipulating assembly into contact with the lumbar region of a user's spine with a contact pressure within a fifth contact pressure range;
(c) to select a massage routine based on stored massage routines and optionally user input and/or sensed data during the adaptation phase;
(d) to control the actuators of each of the sets of actuators to carry out the massage routine based on generally reciprocal motion;
(e) to return the actuators to a rest condition following termination of a session of one or more massage routines, wherein
the controller is arranged to control the pairs of opposed manipulating members within each of the fourth manipulating assembly and the fifth manipulating assembly to move independently to create differential pressure within each respective spine area of a user, and wherein
the controller is arranged to monitor and adjust the contact pressures in the first to fifth contact pressure ranges applied by the manipulating members.

With this arrangement, the inventors have surprisingly provided a spinal massage device which is adaptable to different users while also providing simultaneous massage of an extended region of a user's back. The spinal massage device is superior to the spinal massage devices disclosed in the earlier applications mentioned above.

In use, the spinal massage device provides a pattern of contact with a user's back: this contact pattern may be variable over the duration of a massage routine and/or between different users.

The duration of contact between the contact area of a manipulating member and a user's back contributes to the contact pattern as does the amplitude of motion of the manipulating member. The controller may control the duration of contact and/or the amplitude of motion.

The manipulating members may be finger members or massage fingers.

References to pressure and to differential pressure in the description and claims may refer to a contact pressure and to a differential contact pressure, when appropriate, as would be clear to a skilled person.

Contact pressure is the pressure that exists between two surfaces that are in contact with one another (in this case, the contact area of a manipulating member and a user's back). This pressure is caused by the normal forces that are applied to each surface as a result of their contact.

The contact pressures therefore arise when the manipulating members are brought into contact with a user's back. The contact pressures are generally the result of the force applied by the relevant manipulating member, the contact area of the manipulating member and a user's body weight.

The contact pressures fall within ranges because, for example, a user's contact with different manipulating members within a manipulating assembly may result in different contact pressures.

A measure of force or pressure may be sensed based on current (in the case of electrical actuators) or pressure (in the case of hydraulic or pneumatic actuators) and/or by strain gauges or direct force sensing.

Each contact pressure may be monitored using feedback from current drawn or sensors (by way of example).

The pairs of opposed manipulating members are raised from a starting position which is remote from the relevant region of a user's back (spine).

The spine comprises vertebral regions along the full length of the spine which may have differing levels of tension. Tension creates denser tissue around the spine compared to areas of relaxed, softer tissue. Manipulating members or massage fingers located at different vertebral locations along the spine may require greater or weaker applied force to release the tension, depending on the density of the tissue and a user's personal preference for treatment strength.

The effectiveness of spinal massage can be limited by the personalisation of treatment to individual vertebrae or the area surrounding it. Each vertebra has a spinous process aligned with the centre of the bone, and two transverse processes that extend on either side of the spinous process. To provide massage to reduce tension in the back or neck, force may be applied to an area between the spinous process and each of the transverse processes.

The manipulating members being reactive to the individual conditions of a user's spine at each manipulation location and the relative motion of the manipulating members creates a personalised experience for every user. The manipulating members are arranged to manipulate all the targeted areas of the spine whilst maintaining the precision to manipulate specific locations along the length of the spine at individualised and localised pressure levels.

A pair of opposed manipulating members are raised by moving them to a level which is higher than the level of a rest position.

The manipulating members are configured to move in a general upward direction and in a general downward direction.

In a variant of the present invention, the spinal massage device does not include all of the first to fifth manipulating assemblies.

In the first, third, fourth and fifth manipulating assemblies, the contact areas of a pair of opposed manipulating members are arranged to move towards each other as the opposed manipulating members are raised. A pair of opposed manipulating members may be angled to move closer together as they are raised.

Since pairs of opposed manipulating members are substantially symmetrically disposed about the longitudinal axis of the bed area, the respective contact areas of the first, third, fourth and fifth manipulating assemblies are arranged to move in a direction towards a vertical plane extending through the longitudinal axis as they are raised.

In the second manipulating assembly, the second contact areas of a second pair of opposed manipulating members are preferably arranged to move away from each other as the opposed manipulating members are raised.

Since pairs of opposed manipulating members are substantially symmetrically disposed about the longitudinal axis of the bed area, the respective second contact areas are arranged to move in a direction away from a vertical plane extending through the longitudinal axis as they are raised.

The first contact area may have a size in the range of 200 mm² to 1000 mm², preferably 300 mm² to 800 mm², more preferably 350 mm² to 600 mm². In one example, the first contact area is 400 mm².

Each manipulating member in the first manipulating assembly may have the same or different first contact area.

The second contact area may have a size in the range of 50 mm² to 600 mm², preferably 50 mm² to 300 mm². In one example, the first contact area is 160 mm².

Each manipulating member in the second manipulating assembly may have the same or different second contact area.

The third and fourth contact areas may each have a size in the range of 90 mm² to 500 mm², preferably 100 mm² to 400 mm², more preferably 100 mm² to 300 mm². In one example, the first contact area is 100 mm².

Each manipulating member in the third manipulating assembly may have the same or different third contact area.

Each manipulating member in the fourth manipulating assembly may have the same or different fourth contact area.

The third contact area(s) may be the same as or different from the fourth contact area(s).

The fifth contact area may have a size in the range of 60 mm² to 1000 mm², preferably 100 mm² to 700 mm², more preferably 150 mm² to 500 mm². In one example, the first contact area is 255 mm².

Each manipulating member in the fifth manipulating assembly may have the same or different fifth contact area.

Preferably, the fifth contact area is larger than any or all of the second to fourth contact areas.

In one embodiment, the first contact area is larger than any or all of the second to fourth contact areas.

The first contact area may be smaller than or larger than the fifth contact area.

A distal end of each manipulating member is provided with a contact area. Each contact area is calculated by measuring the area of the distal end of the manipulating member in plan view (i.e., end on).

Depending on a user's back length, a user may enable and/or disable one or more of the fifth pairs of opposed manipulating members of the fifth manipulating assembly, and is preferably arranged to disable and/or enable the fifth pair of opposed manipulating members located closest to the movable leg support.

In one embodiment, the controller is arranged to disable movement of at least the pair of opposed manipulating members within the fifth manipulating assembly that are positioned closest to the bottom region of the bed area.

The second manipulating assembly preferably comprises at least two second pairs of opposed manipulating members.

The fourth manipulating assembly preferably comprises at least four fourth pairs of opposed manipulating members.

One or more manipulating members may comprise an elongate body such as an elongate rod arranged to move in a direction along the length of the body, wherein the direction along the length of the body is an axial direction.

One or more manipulating members may be arranged to be driven by a drive system in the axial direction from a proximal end of the manipulating member.

In one embodiment, the manipulating members of the first, third, fourth and fifth manipulating assemblies each comprise a substantially straight elongate body.

Other configurations are also possible, for example curved manipulating members which operate in a rocking or reciprocating motion.

In one embodiment, the manipulating members of the second manipulating assembly each comprise a curved elongate body.

The actuator arrangement of each manipulating assembly is arranged to drive the respective manipulating members. For example, an actuator may be provided by a motor and lead screw arrangement. Other actuator arrangements including, for example, pneumatics and/or hydraulics may be used in some examples.

Pairs of manipulating members may be coupled together at their proximal ends to be driven simultaneously (together at the same time and in the same direction). One pair of manipulating members may be driven independently of another pair of manipulating members in the same manipulating assembly.

The coupling between a pair of manipulating members may permit axial motion of one manipulating member relative to the other manipulating member in the pair to provide a system whereby the coupled manipulating members may be driven simultaneously, yet maintain a degree of independence by way of a degree of freedom along the axis aligned with that of the axial motion of the manipulating member. The degree of freedom is afforded by the way in which the manipulating members are coupled.

One or more of the manipulating members of the first, third, fourth and fifth manipulating assemblies is preferably mounted at an angle inclined from the proximal end to the distal end of the manipulating member towards a vertical plane extending through the longitudinal axis of the bed area.

One or more of the manipulating members of the second manipulating assembly is preferably mounted at an angle inclined from the proximal end to the distal end of the manipulating member such that movement of each second contact area as the opposed manipulating members are raised includes movement in a direction away from a vertical plane extending through the longitudinal axis of the bed area.

The second contact area of each manipulating member in the second manipulating assembly may be generally cylindrical in shape.

One or more of the manipulating assemblies may include at least one bracket for supporting the corresponding manipulating members, the or each bracket having:
a trunk portion supporting a first arm and a second arm; wherein
the first arm receives one manipulating member of the pair of opposed manipulating members, and
the second arm receives the other manipulating member of the pair of opposed manipulating members; and wherein
the first arm and the second arms optionally each receive a manipulating member of at least another pair of opposed manipulating members.

The or each manipulating assembly may include the bracket wherein the first arm receives one manipulating member of a pair of opposed manipulating members at an oblique angle to a length of the trunk portion, and the second arm receives the other manipulating member of the pair of opposed manipulating members at an oblique angle to the length of the trunk portion.

The first manipulating assembly may include the bracket wherein the first arm receives one manipulating member of a first pair of opposed manipulating members, and the second arm receives the other manipulating member of the first pair of opposed manipulating members, each manipulating member being supported by the respective arm of the bracket at an angle which is inclined away from the vertical direction and is inclined towards the head support area. The first contact areas therefore point in the direction of the head support area. The angles may be the same or different.

Each manipulating member of the first manipulating assembly may be supported by the respective arm of the bracket at an angle which is inclined towards a vertical plane extending through the longitudinal axis of the bed area. The manipulating members may be positioned symmetrically about the vertical plane.

In one embodiment, the first manipulating assembly includes the bracket and the first arm receives one manipulating member of a first pair of opposed manipulating members at an oblique angle to a planar surface of the first arm, and the second arm receives the other manipulating member of the first pair of opposed manipulating members at an oblique angle to a planar surface of the second arm, said planar surfaces of the first arm and second arm being surfaces adjacent distal ends of the respective manipulating members (i.e. the planar surfaces are upper surfaces). The planar surface of the first arm may be coplanar with the planar surface of the second arm.

The first manipulating assembly may be provided by a total of two manipulating members arranged such that they engage two locations in the cervical region of a user's spine, preferably at the Atlanto-Axial-Occipital joint where the skull sits on top of the spine.

While there are other joints in the neck, treating this top neck joint is the most effective way of treating stiff-neck related symptoms, like tension headaches.

The use of two manipulating members enables the top neck joint at the base of the skull to be subject to stretching and/or twisting massage actions.

In one embodiment, the first contact area of each manipulating member may be provided by a roller mounted at a distal end of an elongate body such as an axial rod, wherein the roller is mounted for rotation about an axis which is perpendicular to the length of the elongate body.

The roller may have a diameter of 10 to 40 mm, preferably 15 to 30 mm, more preferably 20 to 25 mm. In one example, the diameter of the roller is about 20 mm.

The roller may have a width of 10 to 40 mm, preferably 15 to 30 mm, more preferably 20 to 25 mm. In one example, the width of the roller is about 20 mm.

The roller may comprise a drum with a rubber cover.

The manipulating members in the first manipulating assembly may optionally be held in place by a T-shaped bracket having a vertical (trunk) portion supporting a first arm and a second arm, wherein the first arm receives a first manipulating member at an oblique angle and the second arm receives a second manipulating member at an oblique angle.

The angle which the elongate body of the first manipulating member makes with a plane of the upper surface of the first arm of the T-shaped bracket may be between 30 and 80 degrees, preferably 40 to 70 degrees, more preferably 50 to 60 degrees. In one example, this angle is about 55 degrees.

The angle which the elongate body of the second manipulating member makes with a plane of the upper surface of the second arm of the T-shaped bracket may be between 30 and 80 degrees, preferably 40 to 70 degrees, more preferably 50 to 60 degrees. In one example, this angle is about 55 degrees.

The upper surfaces of the first and second arms may be substantially horizontal in use such that the elongate body of the first manipulating member and/or the elongate body of the second manipulating member may be between 30 and 80 degrees, preferably 40 to 70 degrees, more preferably 50 to 60 degrees to the horizontal: for example, elongate body may be at an angle of about 55 degrees to the horizontal.

In plan view (from above the spinal massage device), the elongate body of the first manipulating member may make an angle of between 10 and 40 degrees, preferably 15 to 30 degrees, more preferably about 20 degrees with a central axis of the T-shaped bracket, the central axis bisecting the bracket between the first arm and the second arm and being perpendicular to the axis of the vertical portion of the bracket.

In plan view (from above the spinal massage device), the elongate body of the second manipulating member may make an angle of between 10 and 40 degrees, preferably 15 to 30 degrees, more preferably about 20 degrees with a central axis of the T-shaped bracket, the central axis bisecting the bracket between the first arm and the second arm and being perpendicular to the axis of the vertical portion of the bracket.

The manipulating members of the first manipulating assembly are coupled by the T-shaped bracket but, preferably, are otherwise separate.

The second manipulating assembly may be provided by a total of four manipulating members arranged such that they engage four vertebral areas at two locations along the spine on both sides of the spine.

In one embodiment, the second manipulating assembly comprises first, second, third and fourth manipulating members, wherein one second pair of opposed manipulating member comprises the first and third manipulating members and another second pair of opposed manipulating member comprises the second and fourth manipulating members; and wherein the first and second manipulating members are coupled at or adjacent their respective second contact areas and the third and fourth manipulating members are coupled at or adjacent their respective second contact areas.

First and second manipulating members may be arranged on the same side of the spine and may be coupled together to be driven simultaneously. Opposing third and fourth manipulating members may also be arranged to be coupled together and driven simultaneously by virtue of the coupling. The respective manipulating members may be coupled at or adjacent their proximal ends.

The first and third manipulating members may act as a non-coupled pair across a first location of the spine, whilst the second and fourth manipulating members may act as a non-coupled pair across a second location along the spine from the first location.

The second contact area of each manipulating member may be provided by a roller mounted at a distal end of an arcuate arm, wherein the roller is mounted for rotation about an axis which is perpendicular to the general longitudinal direction of the arm.

The roller may have a diameter of 10 to 30 mm, preferably 10 to 20 mm. In one example, the diameter of the roller is about 16 mm.

The roller may have a width of 5 to 20 mm, preferably 5 to 15 mm. In one example, the width of the roller is about 10 mm.

The roller may comprise a drum with a rubber cover.

In addition to being coupled at or adjacent their proximal ends, the first and second manipulating members may be coupled at their distal ends, at or adjacent their respective second contact areas, by respective rollers being mounted for rotation on a common drum.

In addition to being coupled at or adjacent their proximal ends, the third and fourth manipulating members may be coupled at their distal ends, at or adjacent their respective second contact areas, by respective rollers being mounted for rotation on a common drum.

Shoulder blade joints are large floating joint situated at the back of thoracic region. During functional shoulder movements (lifting, throwing, swimming), each of the shoulder joints rotates clock-wise or anti-clockwise. When the upper back and shoulder blade joints become tight, it impedes the shoulder movements, as well as causing various pains and symptoms. Manual therapists often can't ease shoulder blade joint stiffness due to the shoulder blade being large and difficult to hold.

To remove stiffness in shoulder blades more effectively, the present invention provides two roller-type manipulating members for each side of the spine, the manipulating members moving up and out in an arc-movement. The second contact areas on each side of the shoulder blade hit the inner aspect of the shoulder blade at the beginning of the massaging movement. As the manipulating members move vertically upwards and laterally outwards, this results in a slight movement of the shoulder blades and this is effective in removing tension around the shoulder blade joint.

The second set of actuators is configured to move the manipulating members of the second manipulating assembly progressively controllably into or away from engagement with a user's shoulder blade area which movement includes at least a portion of generally arcuate movement of each second contact area in a lateral direction as the opposed manipulating members are raised.

The lateral direction may be away from or towards and away from the longitudinal axis of the bed area.

The second pair of opposed manipulating members are therefore configured to have a generally arcuate movement in use which movement is effective in releasing tension around the shoulder blade joint. The preferred use of a roller at the distal end of the manipulating member provides a smooth rolling action in use.

The third manipulating assembly may be provided by a total of four manipulating members arranged such that they engage four vertebral areas at two locations along the spine on both sides of the spine. First and second manipulating members may be arranged on the same side of the spine and may be coupled together to be driven simultaneously. Opposing third and fourth manipulating members may also be arranged to be coupled together and driven simultaneously by virtue of the coupling. The respective manipulating members may be coupled at or adjacent their proximal ends. The first and third manipulating members may act as a non-coupled pair across a first location of the spine, whilst the second and fourth manipulating members may act as a non-coupled pair across a second location along the spine from the first location. Whilst being driven in respective coupled pairs, individualised treatment can still be applied by each of the coupled manipulating members by virtue of the way in which they are coupled. Configurations of assemblies with different numbers of manipulating members may also be provided.

The manipulating members of the third manipulating assembly are positioned laterally inside the manipulating members of the second manipulating assembly, preferably at substantially the same position along the longitudinal axis of the bed area. The manipulating members of the third manipulating assembly are therefore located closer to the longitudinal axis in a lateral direction than the manipulating members of the second manipulating assembly. Accordingly, the manipulating members of the second manipulating assembly are positioned laterally outside the manipulating members of the third manipulating assembly, preferably at substantially the same position along the longitudinal axis of the bed area. In this regard, a manipulating member of the third manipulating assembly may be adjacent a manipulating member of the second manipulating assembly in the lateral direction.

The thoracic region of a spine tends to accumulate the biggest joint stiffness and is also the hardest in which to remove tension; this is because of the rib cage, meaning that the thoracic region is relatively rigid and the least mobile of all the spinal regions.

To remove stiffness more effectively, the contact areas of the manipulating members of the third manipulating assembly are preferably designed to be relatively small so that the manipulating members can more accurately target the joints.

Each third contact area may have length of 5 to 25 mm, preferably 5 to 20 mm, most preferably 10 to 15 mm. In one example, the length of the third contact area is about 10 mm.

Each third contact area may have width of 5 to 25 mm, preferably 5 to 20 mm, most preferably 10 to 15 mm. In one example, the width of the third contact area is about 10 mm.

In one embodiment, the third contact area of each manipulating member may be provided by a rubber tip or pad mounted at a distal end of an elongate body such as an axial rod.

The manipulating members of the third manipulating assembly may be supported by the same bracket as the manipulating members of the second manipulating assembly.

In this regard, manipulating members arranged in the third manipulating assembly configuration may be optionally held in place by being mounted on a bracket, which is preferably a Y-shaped bracket. Y-shaped brackets have: a vertical (trunk) portion supporting a first arm and a second arm; wherein the first arm receives the first and second manipulating members; and the second arm receives the third and fourth manipulating members.

In this embodiment, the first arm of the Y-shaped bracket may receive the first and second manipulating members of the third manipulating assembly and the first and second manipulating members of the second manipulating assembly; and second arm of the Y-shaped bracket may receive the third and fourth manipulating members of the third manipulating assembly and the third and fourth manipulating members of the second manipulating assembly.

The arcuate arms of the second manipulating assembly may each be supported between a pair of rollers mounted on the respective first or second arm of the Y-shaped bracket.

The angle which the manipulating members of the third manipulating assembly make with the vertical portion of the Y-shaped bracket may be between 30 degrees and 50 degrees. This allows the mounted manipulating members to be angled upwards to be able to engage the spine to both press and massage the tissue about the spine. In an exemplary arrangement, each manipulating member makes an angle of about 40 degrees with the vertical portion of the Y-shaped bracket. The first and second manipulating members may be arranged on a first arm of the bracket, and the third and fourth manipulating members may be arranged on a second arm of the bracket. In other examples, more or fewer manipulating members may be mounted on each arm of the bracket.

In some embodiments, the first, second, third and fourth manipulating members of the third manipulating assembly may be arranged such that their respective distal ends form a rectangular configuration, which may include a square configuration. Other examples include trapezoidal, rhomboidal and parallelogram arrangements, depending on the specific treatment required by a user.

Preferably, the first and second manipulating members may be spaced apart by a first distance in a longitudinal direction of the bed area of the spinal massage device, being a direction along a user's spine. The third and fourth manipulating members may also be spaced apart by the same first distance in the same direction in the longitudinal direction as the first and second manipulating members. The first distance may be calculated centre-to-centre between the contact areas of manipulating members, and may be between 30 mm and 40 mm, more preferably wherein the spacing is 35 mm. The first spacing may beneficially be tuned according to the distance between adjacent vertebrae, which may depend on both the part of the spine being engaged or the size of the user, such that a more effective treatment can be provided.

Preferably, the manipulating members of the third manipulating assembly are spaced apart by a second distance in the lateral direction, being a direction across the spine, wherein the lateral direction is perpendicular to the longitudinal direction. The first and third manipulating members and the second and fourth manipulating members may be spaced apart respectively by the second distance. The distance, also calculated centre-to-centre between the contact areas of the manipulating members, may be between 50 mm and 80 mm. Clearly the linear motion which the manipulating members undergo will change this distance: in fact, the contact areas move closer together as the opposed manipulating members are raised. Therefore, for the avoidance of doubt, this spacing refers to the positions of the manipulating members when they are at rest, i.e. before being actuated to cause their extension towards the intended position of a user's spine.

The fourth manipulating assembly may be provided by a total of eight manipulating members arranged such that they engage eight vertebral areas at four locations along the spine on both sides of the spine. The eight manipulating members may be provided in two sets of four manipulating members configured and operated in the same way as those of the third manipulating assembly.

Since the manipulating members of the fourth manipulating assembly are configured to engage the thoracic region of a user's spine, the contact areas of the manipulating members of the fourth manipulating assembly are preferably designed to be relatively small so that the manipulating members can more accurately target the joints.

Each fourth contact area may have length of 5 to 25 mm, preferably 5 to 20 mm, most preferably 10 to 15 mm. In one example, the length of the fourth contact area is about 10 mm.

Each fourth contact area may have width of 5 to 25 mm, preferably 5 to 20 mm, most preferably 10 to 15 mm. In one example, the width of the fourth contact area is about 10 mm.

In one embodiment, the fourth contact area of each manipulating member may be provided by a rubber tip or pad mounted at a distal end of an elongate body such as an axial rod.

The fifth manipulating assembly may be provided by a total of eight manipulating members arranged such that they engage eight vertebral areas at four locations along the spine on both sides of the spine. The eight manipulating members may be provided in two sets of four manipulating members configured and operated in the same way as those of the third manipulating assembly.

The vertebrae in the lumbar region are larger than the cervical and thoracic vertebrae.

Preferably, the fifth contact area is larger than any or all of the second to fourth contact areas.

Each fifth contact area may have length of 8 to 30 mm, preferably 10 to 25 mm, most preferably 15 to 20 mm. In one example, the length of the fifth contact area is about 17 mm.

Each fifth contact area may have width of 8 to 30 mm, preferably 10 to 25 mm, most preferably 10 to 20 mm. In one example, the width of the fifth contact area is about 15 mm.

In one embodiment, the fifth contact area of each manipulating member may be provided by a rubber tip or pad mounted at a distal end of an elongate body such as an axial rod.

The elongate bodies used to form the manipulating members of the first to fifth manipulating assemblies may be solid or hollow. In a preferred embodiment, where dimensions allow, the elongate bodies are hollow, at least at their distal end, to increase user comfort.

In one embodiment, only the manipulating members of the fifth manipulating assembly are hollow at their distal ends.

Depending on a user's back length, users can enable or disable the set of four manipulating members of the fifth manipulating assembly located closest to the bottom region of the bed area.

If a user is 180 cm or taller, it may be preferable to enable this set of four manipulating members, but this depends on actual back length (a user's shorter or taller height does not necessarily correlate with a corresponding back length). Also, a user with a shorter back length may enable this set of four manipulating members for a gluteal massage.

Optionally, the spacing of the first or second distance in a set of manipulating members may depend on the region of the spine that is being engaged. Preferably, assemblies for treating thoracic and lumbar vertebrae may have a spacing of about 70 mm to 80 mm. Advantageously, the spacing of the members in an assembly matches the spacing and size of the vertebrae in that spinal region such that the treatment can target localised vertebral areas with improved accuracy or, in the case of the second manipulating assembly, the spacing of the manipulating members matches the spacing and size of a user's shoulder blade area.

Advantageously, coupling and controlling the driving of manipulating members on the same side of the spine, as opposed to coupling members about the same spinal or vertebral location, can allow a wide variety of movements to be applied to the muscles and tissue of the spine.

In the third to fifth manipulating assemblies, the manipulating members located on one side of the longitudinal axis of the bed area may be generally aligned in the longitudinal direction and the manipulating members located on the other side of the longitudinal axis of the bed area may be generally aligned in the longitudinal direction. The manipulating members of the second manipulating assembly may be located laterally outside the manipulating members of the third to fifth manipulating assemblies when viewed in the direction of the longitudinal axis.

In an embodiment using Y-shaped brackets, the angle which the manipulating members make with the vertical portion of the Y-shaped bracket may be between 30 degrees and 50 degrees. This allows the mounted manipulating members to be angled upwards to be able to engage the spine to both press and massage the tissue about the spine. In an exemplary arrangement, each manipulating member makes an angle of about 40 degrees with the vertical portion of the Y-shaped bracket.

The first and second manipulating members may be arranged on a first arm of the bracket, and the third and fourth manipulating members may be arranged on a second arm of the bracket. In other examples, more or fewer manipulating members may be mounted on each arm of the bracket.

Personalisation may be afforded to the manipulating assemblies in the different regions along the spine such as: differing heights of the assemblies to account for the curvature of the spine; longer or shorter manipulating members with variations in diameter may be used depending on the geometry of the spinous and transverse processes of the particular region of the spine; the manipulating members may be mounted with varying degrees of ranges or freedom of axial motion; adaptations in material or size of the components for particularly large, small, heavy or light users may be made; arrangements suitable to treat particular conditions.

In some examples, the spacing between adjacent manipulating assemblies (in the lateral and/or longitudinal directions) may be adjustable to account for different users' physiology. Indeed, many of the physical dimensions presented herein may be adjustable within their respective ranges to account for physiology. In some cases, the manipulating members for manipulating spinal regions in different areas of the spine are substantially identical to one another, and a different spacing between adjacent members is provided by mounting the members at a different point along their length. In other examples, the members for use in different parts of the spine are simply longer or shorter, thinner or thicker, etc. as required. In yet further examples, the brackets may be different shapes or sizes to hold the manipulating members in the desired arrangement.

In an embodiment using the Y-shaped bracket, this bracket may be arranged such that the manipulating members engage the spine at a different angle to the vertical in different regions, or indeed at specific locations within a region. Also, the Y-shaped bracket may be configured in a different geometrical orientation.

A Y-shaped bracket or T-shaped bracket is particularly advantageous because it provides stability for a number of manipulating members, which may be on opposing sides of the spine, and also allows the manipulating members to be disposed at an angle such that they can press into and massage the tissue in the vertebral area.

When one or more manipulating members comprise an elongate rod, the elongate rod may have a diameter between 10 mm and 15 mm, more preferably the diameter is about 12 mm. The contact area at the tip of the elongate rod may be configured to have similar shape and hardness to a fingertip to imitate massage by a masseuse, and may have a diameter of between 5 mm and 10 mm, more preferably about 8 mm.

In some embodiments, the contact area of the manipulating member is pliable. The pliable contact area may be made of a soft rubber or similar material to provide comfort to the user. The hardness of the pliable contact area may have a hardness of 60 or less, as measured on the Shore “A” scale. The pliable contact area may have a thickness (for example an extent in a distance along the axial direction of the manipulating member) of between 2 mm and 3 mm, preferably wherein the thickness is about 2.5 mm. The shape of the contact area may be hemi-spherical or spherical. The contact area being rounded provides additional comfort to the user over other configurations whilst also maintaining accuracy. The sizes and thicknesses of the contact areas given above have been found to be particularly effective.

A manipulating member may be biased in a direction towards its distal end and the drive system may operate to retract the manipulating member by pulling it in a direction towards its proximal end to overcome the biasing. The biasing may be provided by an adjustable biasing system. For example, a spring held under compression, and a screw thread may be used to adjust the compression of the spring to alter the restoring force.

The actuator assembly may comprise a reciprocating actuator and each manipulating member may be connected to the reciprocating actuator by a Bowden cable.

The actuator may be decoupled from its respective manipulating member by a spring. Direct drive decoupling avoids a situation where a motor or other actuator forces the manipulating member into a user's spine; instead the force may be limited by choosing a spring of suitable spring constant. The spring, for example, may be chosen with a spring constant which gives 300 N at start of motion, dropping to 140 N at the end of the motion. In this case, it also provides the restoring force for the Bowden cables, since Bowden cables are unable to push the manipulating members back towards the user's spine. This inability of a Bowden cable to push makes this a particularly suitable drive system as the drive system can never force the manipulating members into a user's spine with more force than is exerted by the spring, which can be limited to a desired value by choosing a spring of appropriate spring constant.

Optionally, the drive system drives the manipulating members to cause a movement between 0 mm and 50 mm, for example 20 mm in the axial direction. The drive system may drive the manipulating members at a speed between 5 mm/s and 15 mm/s, for example 10 mm/s. These distances and speeds have been found to provide particularly effective treatment.

The manipulating assembly may optionally comprise sensors for detecting a measure of force and/or overextension of the manipulating members. For example, the sensor may utilise the Hall Effect or other proximity sensors. The sensor can be linked to a cut switch, at least for that actuator, if the sensor determines that a threshold (for example: speed, distance, force) has been reached. Each user can have an individualised threshold, within a pre-determined maximum safety extension. Sensors may ensure that treatments conform to a particular massage routine and/or that particular thresholds may not be exceeded for the avoidance of pain or injury.

The spinal massage device of the present invention may comprise: a chassis; a platform supported above the chassis for supporting a user on their back and having an aperture through the platform for receiving a user's spine; and a plurality of manipulating assemblies mounted on the chassis below the platform with their respective manipulating members extending into the aperture to engage a user's spine.

The manipulating assemblies may be arranged into groups; wherein adjacent manipulating assemblies in the same group are separated by a distance in a first range; adjacent assemblies in different groups are separated by a distance in a second range; and distances in the first range are smaller than distances in the second range. In some examples, all of the distances of the first range are smaller than any or all of the distances in the second range.

Advantageously, the spinal massage device of the present invention is ergonomically designed for both comfort to the user and effectiveness of the treatment. The spacing of the manipulating members in an assembly, or within a group, may be constant, and may be set to a different distance depending on the group or indeed the assembly. This allows the device to target specific portions of a user's back. As the user is supported by the platform, the user's own weight presses their spine downwards into the aperture. The engaging members can then press into the user's back at specific locations. When driven by the drive system, the manipulating members press into the user's back with varying force to provide personalised treatment.

The manipulating assemblies may be divided into groups comprising: a first group comprising at least one manipulating assembly arranged to engage vertebral areas in the cervical region of the user's spine; a second group comprising at least one manipulating assembly and arranged to engage a user's shoulder blade area; a third group comprising at least two manipulating assemblies and arranged to engage vertebral areas in the thoracic region of the user's spine; and a fourth group comprising at least one manipulating assembly and arranged to engage vertebral areas in the lumbar region of the user's spine. Any combination of one, two, three or four groups may be used, which may depend on the user being treated, or the massage routine of a particular user.

In certain embodiments, there may be up to a total of at least 22 manipulating members spaced along the length of the spine, advantageously arranged to maximally address the spine. It will be appreciated that a spinal massage device may have any number of manipulating members. In a preferred embodiment, 26 manipulating members are used.

A first group of, for example, the first pair of opposed manipulating members, may be arranged to engage the cervical region of a user's spine. A second group of, for example, the second pair of opposed manipulating members, may be arranged to engage the shoulder blade area of a user. A third group of, for example, two third pairs of opposed manipulating members may be arranged to engage the thoracic region. A fourth group of, for example, three or four fourth pairs of opposed manipulating members, may be arranged to engage the thoracic region. A fifth group of, for example, four fifth pairs of opposed manipulating members, may be arranged to engage the lumbar region.

Optionally, the trunk portion or vertical portion of each bracket, which may be a Y-shaped bracket or a T-shaped bracket, is adjustable to change a distance which the corresponding manipulating assembly extends into the aperture (that is the adjustment raises or lowers the bracket relative to the chassis). The trunk portion or vertical portion of the bracket may be configured at different heights (i.e. spacing from the chassis in the direction of the expected location of the user's spine) along the bed to account for the natural curvature of the spine. In the cervical region, for example, it may have a length of around 220 mm and in the thoracic and lumbar regions it may have a length of 180 mm.

The cervical region may, in general, be positioned higher than the lumbar and thoracic regions so as to support the neck area in a more natural and comfortable position. The diameter of the support shaft may be 25.1 mm, and it may have a circular or D-shaped cross-sectional area, for example. The vertical portion of each bracket may also be individually adjustable to change a distance which the corresponding manipulating assembly extends into the aperture. Beneficially, this may be used to account for the curvature of the spine or the degree of therapy required.

The actuator may advantageously be mounted on bracket to mechanically isolate it from the chassis, so as to inhibit transmission of mechanical vibrations from the actuator to the chassis. Beneficially, inhibiting transmission of vibrations to the chassis ensures that separate or adjacent assemblies and/or manipulating members are capable of independent manipulation, and are not influenced by contributory external environmental factors. It also helps to keep the sound levels to a minimum.

The platform of the spinal massage device may be arranged with a padded upper surface, which may be comprised of foam or other materials that are comfortable for the user to lie on for the duration of the treatment. The profile of the foam may be shaped for comfort. In some embodiments, a profile of the shaped foam may have sloping walls forming a V-shape or sloping walls with a horizontal base portion joining the lower edge of the sloping walls. Either arrangement can make it easier for a user to correctly position themselves on the device. The aperture of the spinal massage device, where the manipulating members are arranged to be, may be positioned or located in the lowest point of the V or in the horizontal base. The sloping walls of the V-shaped configuration may make an angle of between 15° to 25° with to the horizontal, more specifically wherein the sloping walls may make an angle of between 15° and 25° to the horizontal, which advantageously provides comfort and support to the user.

The movable leg support is operable to provide support to a user's legs at a variable height, optionally wherein the height of the movable leg support is controlled by the controller.

Preferably the movable leg support has a leg support actuator configured to move the movable leg support progressively controllably into a raised or lowered position and wherein the controller is arranged to control the movable leg support via the leg support actuator

Prior to use of the spinal massage device, the movable leg support is commonly in a fully lowered position for storage or access, this being a stowed position.

In the stowed position, the movable leg support is preferably stored beneath the bed area, at least in part, to provide a compact spinal massage device.

The leg support actuator may be configured to rotate the movable leg support from the stowed position by more than 135 degrees, preferably by about 170 to about 180 degrees, to the elevated position.

Storing the movable leg support in the stowed position provides compactness. Elevating the movable leg support provides leg support and therefore comfort to a user and helps to ensure that a user's body weight is advantageously distributed over the bed area of the spinal massage device, leading to a more effective massage treatment.

The movable leg support may comprise at least one rotatable side arm mounted for rotation at or towards the bottom region of the bed area: the axis of rotation of the side arm is preferably perpendicular to the longitudinal axis of the bed area: the side arm may be mounted for rotation at or towards a proximal end of the side arm.

In a fully lowered position, the or each side arm of the movable leg support may generally extend in a vertical direction below the level of the bed area.

In a semi-raised position, when the movable leg support is at a halfway point, the or each side arm may be rotated outwardly and upwardly by approximately 90 degrees from the fully lowered position.

In a fully elevated position, the or each side arm may be rotated outwardly and upwardly by approximately 170 to approximately 180 degrees from the fully lowered position.

The leg support actuator is preferably configured to rotate the or each side arm from the stowed position by more than 135 degrees, preferably by about 170 to about 180 degrees, to the elevated position of the movable leg support. The leg support actuator is preferably configured to elevate the or each side arm to a position which extends upwards by at least 45 degrees, preferably by about 80 to about 90 degrees, to a horizontal plane extending through the longitudinal axis of the bed area. The movable leg support may comprise two rotatable side arms mounted for rotation at or towards the bottom region of the bed area, a side arm being located in each of the opposed side regions of the bed area.

The movable leg support may also comprise one or more of a first member, a second member and a third member. The second member may be mounted for rotation about an axis which is parallel to the axis of rotation of the side arm.

When the moveable leg support is an elevated position, the first member is proximate the bottom region of the bed area, the second member is intermediate the first member and the third member and the third member is distal the bottom region of the bed area.

The second member may be configured to avoid a user's clothing (e.g. trousers) becoming caught during movement of the movable leg support. The second member may comprise a roller. The third member may be adapted to support a user's calves in an elevated position. The third member may comprise a foot rest. The third member may be mounted to move (for example, about a pivot) between a folded position and an unfolded position.

In one embodiment, the movable leg support comprises a pair of side arms mounted for rotation at or towards a proximal end of each side arm: a first member mounted between the proximal and distal ends of the side arms and preferably spanning the distance between the side arms; a second member mounted for rotation between the side arms, at or towards distal ends of the side arms; and a third member mounted between the side arms, at or towards the distal ends of the side arms: the second member being positioned between the first member and the third member in the longitudinal direction of the bed area; the first member, the second member and the third member all extending in the lateral direction.

In such an embodiment, in a fully lowered position, each side arm of the movable leg support, together with the first member extending between them, may extend in a generally vertical direction below the level of the bed area. The third member may move into a folded position for storage beneath the first member. Of these three members of the movable leg support, the second member may be located at the lowest level below the level of the bed area.

In a semi-raised position, when the movable leg support is at an approximate halfway point, the side arms, together with the first member extending between them, may be rotated outwardly by approximately 90 degrees from their fully lowered position. The first member may be supported by the side arms in a generally horizontal position at a level which approximately matches the level of the bed area. The third member may unfold and may extend in a generally vertical direction below the level of the bed area.

In a fully elevated position, the side arms, together with the first member extending between them, may be rotated outwardly by approximately 180 degrees from the fully lowered position. The first member may be supported by the side arms in a generally vertical position above the level of the bed area. The third member may be supported in a generally horizontal position above the level of the bed area.

The leg support actuator is preferably configured to rotate the first member from the stowed position by more than 135 degrees, preferably by about 170 to about 180 degrees, to the elevated position of the movable leg support. The leg support actuator is preferably configured to elevate the first member to a position which extends upwards by at least 45 degrees, preferably by about 80 to about 90 degrees, to a horizontal plane extending through the longitudinal axis of the bed area.

In such an embodiment, the first member may be rotated outwardly by approximately 170 to approximately 180 degrees from the fully lowered position of the movable leg support.

The leg support actuator is preferably configured to elevate the third member to a position which is substantially parallel to a horizontal plane extending through the longitudinal axis of the bed area.

The leg support actuator may comprise an extension mechanism such as a gear system to raise and lower the movable leg support.

The movable leg support may be raised and lowered at either constant, variable or adjustable speeds. Force sensing may be used.

The controller may be arranged to control the movement of the movable leg support whereby during at least a portion of the movement the movable leg support moves at a nonconstant speed.

The controller may be arranged to control the movement of the movable leg support whereby during at least a portion of the movement the movable leg support moves at a reduced speed as it reaches its raised position or its lowered position.

The controller may be arranged to control the movement of the movable leg support whereby the movable leg support moves at a relatively fast speed over a major portion of travel and at a relatively low speed over a final portion of travel when lowering and/or raising of the movable leg support.

The speed of raising and/or lowering the movable leg support may be advantageously reduced at or towards the end of its movement to prevent finger trapping.

The controller may be arranged to lower and/or retract the movable leg support after termination of a massage routine.

In use of the spinal massage device, each manipulating member is arranged to engage a user's spine at a respective vertebral area between a spinous process and a transverse process; the or each manipulating member may be elongate and arranged to be driven in an axial direction from a proximal end and having a portion for engaging the spine at a distal end; wherein the controller is configured to actuate the manipulating members to apply pressure to their respective vertebral areas, such that a plurality of the manipulation members is driven simultaneously and independently.

The controller may be arranged to store initial massage positions or approximate initial massage positions of one or more of the manipulating members for the massage routine of a user.

This saves set-up time and enables the manipulating members to move relatively rapidly from the rest condition to initial massage positions: this may also provide generally less travel for the manipulating members.

The controller may be arranged to update the stored initial massage positions.

The controller may be arranged to adjust a stored massage routine based on a sensing of force and/or user input.

The controller may be arranged to memorise a stored massage routine for a specific user.

The stored massage routines may include progressive changes between applications.

The controller may be arranged to adapt stored massage routines by learning changes in force or pressure from the different sets of actuators.

The controller may be arranged to learn changes in force or pressure from the different sets of actuators and adapt a stored massage routine.

The controller may determine a user's spinal anomalies.

The controller may be arranged to respond to a user description of an ailment and correlate the description with one or more stored massage routines.

The controller may therefore learn from the user description and correlate the user symptoms with one or more massage routines. The user may be asked questions about symptoms or about detected spinal anomalies so that the controller can find a suitable stored massage routine or adapt a stored massage routine.

The controller may be arranged to recognise a user, for example from a phone app identifier, and to resume a massage routine where it left off.

The controller including logic may be arranged to perform the following steps: determining control signals for controlling a plurality of manipulating members of the spinal massage device based on a stored massage routine, wherein the manipulating members are arranged to engage a user's spine at a respective vertebral area between a spinous process and a transverse process; applying the control signals to drive the one or more manipulating members in at least one cycle to implement a massage routine; receiving feedback signals from a plurality of sensors for monitoring the behaviour of each manipulating member indicative of a pressure and/or movement applied on a user's spine by the plurality of manipulating members during the at least one cycle; and determining adjusted control signals based on the control signals of the stored massage routine and the received feedback.

The stored massage routine may be stored locally (on a control system of the device, for example) or remotely and the massage routine may comprise a number of cycles. The cycle may refer to one complete circuit of each of the manipulating members of the device moving from a rest position and returning to that rest position, or a cycle may refer to a series of movements of the manipulating members in a defined manner to be repeated in subsequent cycles.

Advantageously, determining adjusted control signals from feedback signals provided by the sensors throughout the massage routine can allow personalised treatments to be determined both during the treatment and for later treatments. It can also allow for improved user treatment in general or for treatments specific to a user. Massage routines may be stored with the adjusted control signals such that when the user returns, or the next user arrives, the massage routine has been optimised and is ready to provide instruction for a subsequent treatment. The adjusted control signals may be indicative of how long it takes tissue to relax in specific users, or which motions are particularly effective at releasing tension, such that subsequent massage routines can be designed according to received feedback.

A massage routine may specify parameters including one or more of: total length of treatment or lengths of particular stages or cycles within the treatment, distance of manipulating member to travel in one movement (which may change, or dynamically change, throughout a treatment), operating speed of a manipulating member (which may also change throughout a treatment); motions (e.g. ripple, twist, squeeze, rock) to be performed throughout the treatment and, optionally, instructions on how to achieve these motions using the plurality of manipulating members; duration and sequences of motions; force/pressure to be applied to the spine; and/or other parameters which can be controlled by a central unit or control system.

Adjusted control signals may advantageously be determined using machine learning algorithms. The feedback signals may be collated and analysed, for example, using machine learning techniques, and may generate adjusted control signals based on the received feedback.

In some examples the adjusted control signals can be applied in the next cycle, which may be one of a plurality of cycles in a massage routine. The massage routine may be generated or updated, for example continuously or dynamically updated, based on the adjusted control signals, which may be influenced by one or both of feedback signals and data collected from previously executed methods on one or more components of the drive system which perform actuation of the manipulating members. Feedback data from signals may be collected from users, for example at a central unit or memory, over one or more treatments, which may optionally be used to update massage routines.

Adjusted control signals may specify, for example, an adjusted speed or range of extension with which to drive the manipulating members. The adjusted control signals may be adjusted as the tissue around the engaged area of the spine is relaxed, for example by reducing the power or force of the members into the back. The signals may also specify, for example, that groups at different regions along the spine are to be turned off once a desired relaxation of the tissue has been achieved. Differing parameters can be applied along the length of the spine depending on the relative stiffness of the area that is being manipulated, and adjusted control signals may reflect this.

Massage routines are optionally stored in a library or database of selectable massage routines. The library may comprise general profiles and/or personal massage routines for a specific user based in part on feedback signals from the user. General massage routines may comprise, for example, pre-determined treatments which may be designed to treat particular conditions or which may form part of a series of recommended massage routines or which may have been optimised based on analysis of a number of treatments on a plurality of users. Personal profiles may be determined based on a selected general profile that has been adapted for the individual based on previous or manually entered settings or treatments. Massage routines for treating a specific condition, or conditional massage routines, may also be developed based on data collected from users with that condition. Other profiles might be aimed at achieving particular results, identified by statistical analysis of previously performed treatments.

The library may be stored on a central server, which may be stored in a virtual or physical server and may be accessible by a wired or wireless connection, for example via the internet. The central server may have a memory in which to store massage routines and a processor with which to receive and process signals, and may be incorporated with the spinal device architecture or be remote. The central server may be accessible from a number of distributed geographical locations such that spinal massage devices in different locations may be provided with the same massage routines. Massage routines may be downloadable from the central server directly to the spinal massage device being used, or by a number of independent steps. Personal massage routines may be stored centrally so that a user's personalised treatment details can be accessed from any location and applied to the spinal massage device in that location, beneficially meaning that the user can experience personalised treatment from anywhere.

This method may be performed on each or any of the massage routines in the library such that a plurality of general massage routines can be generated based on performing the above method on multiple massage routines, or all the massage routines, in the library. A plurality of different users may be treated with one or more of the massage routines in the library. General profiles may be updated, for example dynamically updated, after each iteration of a selected massage routine or during execution of the massage routine.

Processing the signals preferably comprises using machine learning algorithms to analyse the volumes of data and/or determine statistics based on received feedback signals. Optionally, the library may be stored on a central server, wherein the server is accessible to provide a stored massage routine to a spinal massage device at one of a plurality of locations. The locations may be spaced apart by a range from around a few meters, for example within one treatment centre, to locations which may be on different sides of the Earth.

In a treatment sequence, a user self-positions on the bed area at the beginning of the session using the head support area for orientation and comfort. The movable leg support is raised to support the user's legs in a bent position. The first pair of opposed manipulating members start moving, prompting the user to adjust the body position so that the first contact areas touch the top joint of the neck, at the base of the skull. The spinal massage device starts scanning the user's back and all the manipulating members adopt a position which accommodate the user's back shape. Once the scanning is completed, the position of each of the manipulating members become locked in, creating a unique shape of the user's back. The treatment can then begin, where the user can change settings in real-time, for example, Speed (fast, moderate, slow), Strength (0-10), Treatment Area, Duration and Heat Temperature (high, medium, low, off).

The manipulating members of the first manipulating assembly may protrude in the resting or storage state to assist the user in aligning the spine along the bed area on initial mounting.

According to another aspect of the present invention there is provided a spinal massage device for a user having a plurality of actuators arranged to apply force to a user lying on the spinal massage device via a plurality of manipulating members, the actuators each having a respective motor, the device comprising a controller arranged to determine a measure of force applied by an actuator based on a measure of current drawn by the actuator and having a control algorithm for applying force sequentially to different manipulating members, the controller being further arranged to store data relating to a massage routine for a user, the controller having memory for storing an initial set of calibration parameters for use in determining a measure of force based on a measure of current applied to the motor, the controller having an adaptation module for monitoring changes in applied current for given movements for a given user over a series of at least three massage routines and for determining a change in one or more calibration parameters in response to variation of current over time associated with a given movement.

Each massage routine may be the same as or different from another massage routine.

A measure of force may be obtained based on the current drawn by an actuator and/or by a force or pressure sensor or strain gauge coupled to a mounting. It is not necessary to have an accurate absolute measure of force or pressure but to detect variations. For example, the current drawn by the actuator may be a first low level when moving unimpeded freely, a second higher level when first contacting a user's clothing, a third higher level when starting to apply pressure to tissue and a fourth highest level when applying sufficient force to lift a portion of the user off the bed.

The force may vary between users as a function of amplitude of motion of each manipulating member, a user's body weight and shape and amount of body fat. Adjusting the motion of a manipulating member, for example adjusting the extent to which it moves into engagement with a user's back, has the effect of adjusting the force.

In addition, the current drawn by the actuator may vary due to tolerances of individual motors, differences in gearing and lubrication state and wear, and with wear of linkages and bearings. Nonetheless it is found that the current applied can be a useful measure of force without requiring precise force sensing. Advantageously the machine adapts calibration over time.

The adaptation module preferably takes the amplitude of motion of a manipulating member as a parameter and determines changes in the variation of current with the amplitude over time.

The spinal massage device may further include a user adaptation module arranged to determine a change in user characteristics over a series of massage routines and to adjust or provide an option to adjust one or more parameters of the massage routine.

For example, if a user initially has a certain amount of subcutaneous body fat, the force for a given amplitude of motion will have a particular variation pattern. If the user gains or loses that fat, the force pattern will vary, for example the force will tend to increase more with a given movement into the skin for a more toned or bony user.

The adaptation can be in discrete steps or quasi continuous.

The measure of force may be quasi continuous or quantised into a number of threshold ranges.

In one embodiment, the speed of the motor of the actuator is generally consistent such that this motor speed is not a factor when varying the force applied to a user lying on the spinal massage device.

### BRIEF DESCRIPTION OF THE DRAWINGS

Aspects of the invention will now be described in detail with reference, by way of illustration only, to the accompanying Figures, in which:

FIGS. 1 and 2 illustrate two pairs of opposed manipulating members in accordance with the fourth and fifth manipulating assemblies that form part of a spinal massage device of an embodiment of the present invention;

FIG. 3 illustrates a cap for a manipulating member of the third or fourth manipulating assembly wherein FIG. 3A is a plan view of the cap, FIG. 3B is a side view of the cap, FIG. 3C is an end view of the cap and FIG. 3D shows a perspective top view and a perspective bottom view of the cap;

FIG. 4 illustrates a cap for a manipulating member of the fifth manipulating assembly wherein FIG. 4A is a plan view of the cap, FIG. 4B is a side view of the cap, FIG. 4C is an end view of the cap and FIG. 4D shows a perspective top view and a perspective bottom view of the cap;

FIGS. 5, 6 and 7 illustrate a pair of opposed manipulating members in accordance with the first manipulating assembly that form part of a spinal massage device of an embodiment of the present invention;

FIG. 8 illustrates a roller for a manipulating member of the first manipulating assembly wherein FIG. 8A is a plan view of the roller, FIG. 8B is an end view of the roller and FIG. 8C is perspective view of the roller;

FIGS. 9, 10 and 11 illustrate pairs of opposed manipulating members in accordance with the second and third manipulating assemblies that form part of a spinal massage device of an embodiment of the present invention;

FIG. 12 illustrates a roller for a manipulating member of the second manipulating assembly wherein FIG. 12A is a plan view of the roller, FIG. 12B is an end view of the roller and FIG. 12C is perspective view of the roller;

FIG. 13 illustrates an array of manipulating assemblies;

FIG. 14 illustrates an array of manipulating assemblies mounted in a frame;

FIG. 15 illustrates a section of an array of manipulating assemblies mounted in the frame;

FIG. 16 illustrates the frame wherein a movable leg support is in a lowered position;

FIG. 17 illustrates the frame wherein the movable leg support is in a semi-raised position;

FIG. 18 illustrates the frame wherein the movable leg support is in a fully raised position; and

FIG. 19 illustrates a spinal massage device in accordance with an embodiment of the present invention.

### DESCRIPTION OF EXAMPLE EMBODIMENTS

In accordance with the present invention, one or more forces or pressures are applied by a plurality of manipulating members to the soft tissue located adjacent each side of the vertebral column in the vertebral area between the spinous and transverse processes. The one or more forces are applied partially towards the base of the area between the spinous and transverse processes and partially towards a second side of the vertebral column opposite the first side such that a substantial length of vertebral column is rotated or rocked by the action of said forces on a plurality of vertebral areas between the spinous and transverse processes, wherein the plurality of vertebral areas may experience different applied forces caused by an imbalance of tension in said vertebral area.

To create movement of the spine, the area of the spine between the spinous and transverse processes should be engaged. This can be achieved by coordination of manipulating members such that they are configured to act as a pair, contacting both sides of a vertebral area about the spine. A substantial amount of force may be required in persons with stiff back problems, or indeed varying forces may be desired at locations with varying levels of tension along the length of the spine.

The aim of the apparatus is to create movement of the spine to cause the vertebral junctions to loosen up and relieve tension. The vertebrae of the spinal column may be required to be independently articulated to accommodate for the differences in physical stiffness or tension in each individual junction along the length of the spine.

Loosening of the vertebral junctions can be achieved by articulating a plurality of manipulating members at each vertebra, one member on each side of the spinal column, such that a set of manipulating members may be independently operated to achieve a personalised massage routine that can be adapted to treat variations both along a spine and for any spine.

The movements are applied uniformly, gradually, firmly and over prolonged periods of time. A suitable frequency of movements lies in the range of about 6 to 10 movements per minute, although other frequencies may also impart benefits.

Although a reasonably substantial amount of force is often required, caution must be exercised not to apply excessive force in local points so as to not cause bruises, pain, excessive discomfort or to further inflame an existing injury.

Individually addressing each articulating or manipulating member of a set of members that are required to manipulate the full length of the spine requires intensive energy and resource use to operate the members at each desired intensity for the particular location of the spine that the member is addressing.

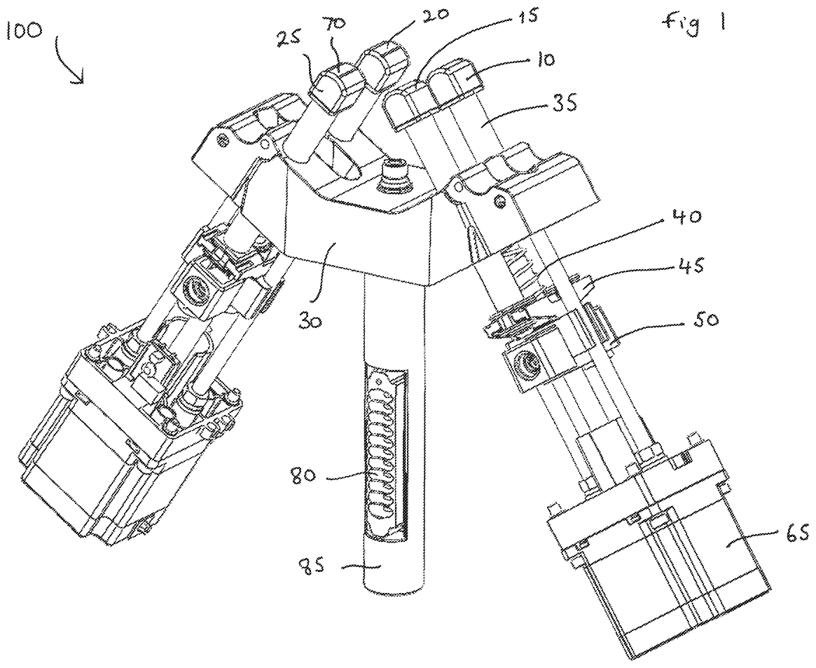

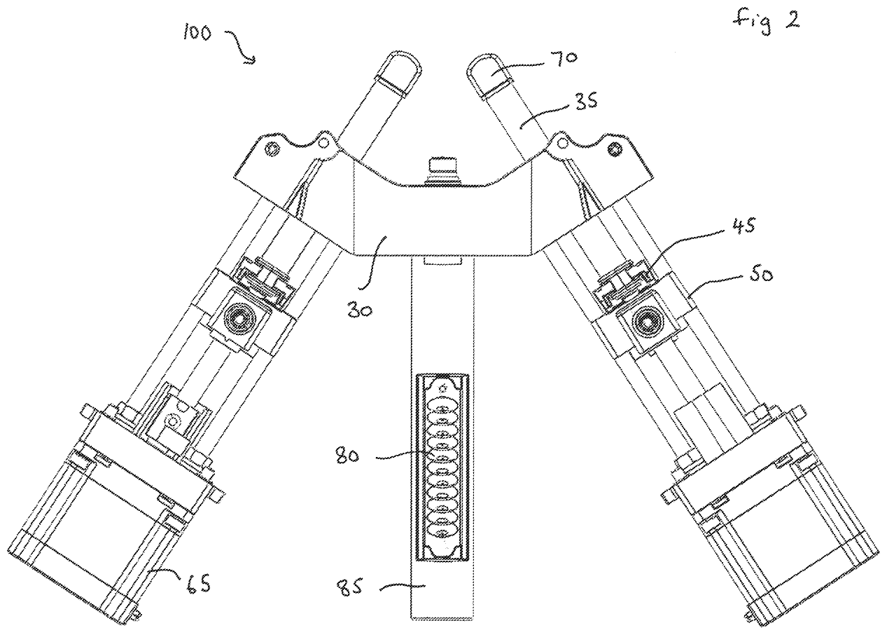

Referring to FIG. 1 and FIG. 2, two pairs of opposed manipulating members in accordance with the fourth and fifth manipulating assemblies of the spinal massage device of the present invention is described.

A fourth or fifth manipulating assembly 100 comprises a first manipulating member 10, a second manipulating member 15, a third manipulating member 20, and a fourth manipulating member 25, mounted together, each of which may be configured to engage the spine at a different vertebral area and may each be independently addressable and controllable.

Each of the members in the fourth and fifth manipulating assemblies comprises an elongate rod 35, which has a cap 70. The rod can be made from a material that is suitably strong and resistant to deformation yet reasonably lightweight, for example a metal such as stainless steel.

In FIGS. 1 and 2, the caps are substantially arch-shaped. Other shapes and configurations of caps are possible. The caps provide each manipulating member with a generally rounded contact area.

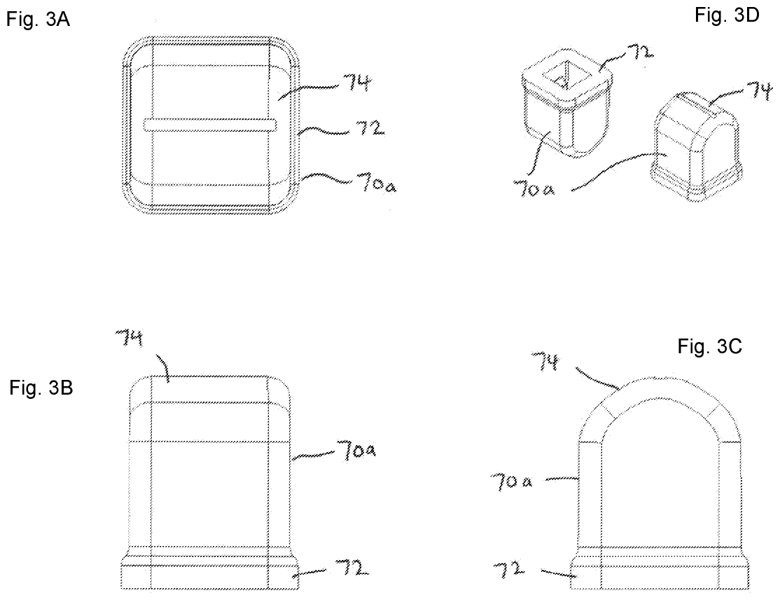

Referring to FIGS. 3A to 3D by way of example, in the fourth manipulating assembly, cap 70a has a rounded shape at its distal end and has the following dimensions: height 14.5 mm, width 12 mm and length 12 mm.

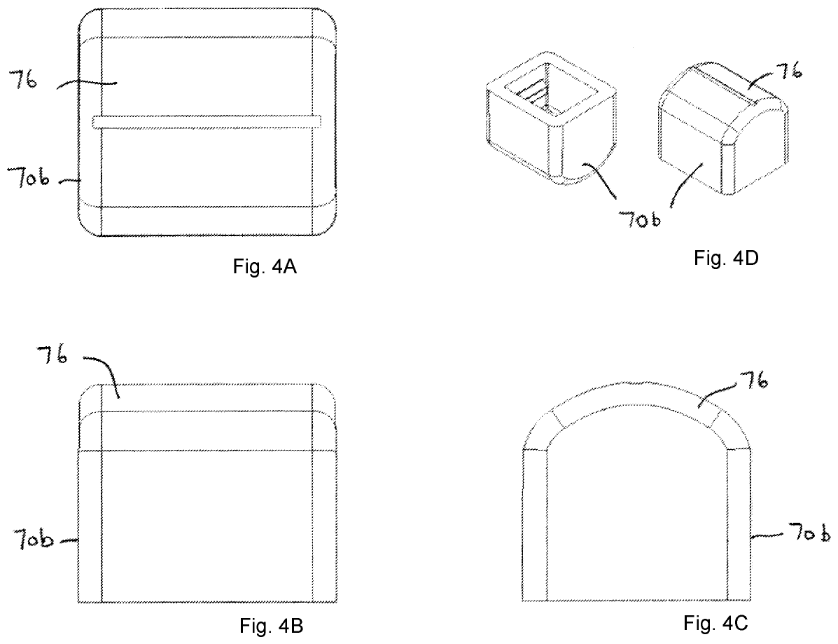

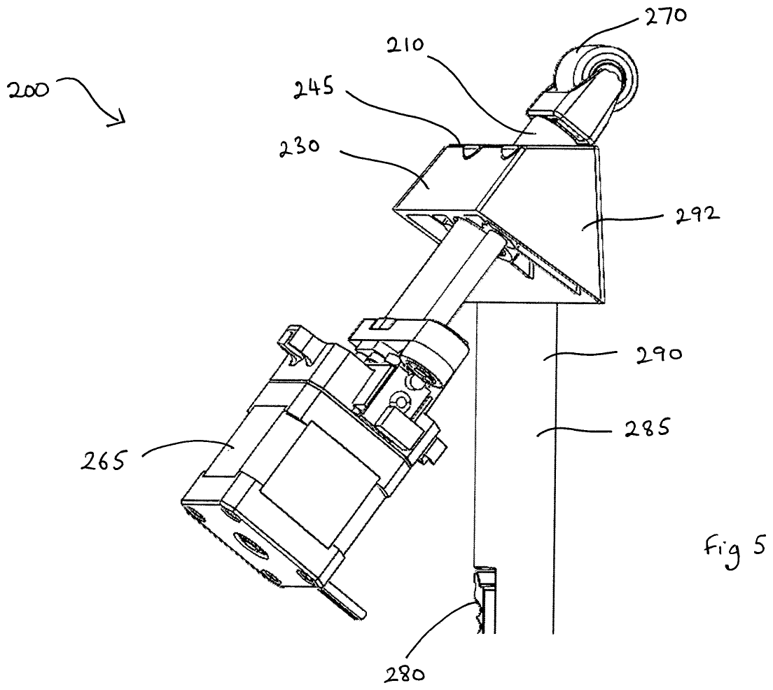

Referring to FIGS. 4A to 4D by way of example, in the fifth manipulating assembly, cap 70b has a rounded shape at its distal end and has the following dimensions: height 14.5 mm, width 15 mm and length 17 mm.

The fourth contact area 74 of each manipulating member of the fourth manipulating assembly is about 100 mm². Each contact area 74 is calculated by measuring the area of the distal end of the manipulating member in plan view (i.e., end on, as shown in FIG. 3A). When measuring length and width to calculate the contact area, the 2 mm wide flange 72 around the base of the cap is not taken into account as the flange is not positioned at the distal end of the manipulating member and so will not engage a thoracic region of a user's spine.

The fifth contact area 76 of each manipulating member of the fifth manipulating assembly is about 255 mm², calculated using the same measurement method as that used for the fourth contact areas, with reference to FIG. 4A.

Caps 70a and 70b may be rubber or another material that is pliable. The resilient and deformable properties of the caps provide a cushioned interface between the spine and the elongate rod 35. The pliable pad may have a hardness of 60 or less, as measured on the Shore “A” scale.

The elongate rod 35 moves linearly along an axis defined along the longer side of the rod, along its centre, the movement being controlled by an actuator comprising a motor, a coupling and a lead screw. A lead screw translates the rotational motion of the motor to linear movement, which moves the manipulating members to which it is coupled up and down along the axis of the elongate rod 35 such that the manipulating members penetrate the vertebral area at an angle of 50 degrees to the horizontal defined by the orientation of a supporting head 30.

It will be appreciated that other actuating means including pneumatic, hydraulic, spring decoupled designs, and Bowden cable driven designs may be used to drive the coupled manipulating members. Indeed, any suitable actuator may be used, many of which will be familiar to skilled workers in the field.

Distances between the manipulating members in an assembly vary depending on the spinal region which they are designed to treat. A distance between the manipulating members shown in FIGS. 1 and 2 that address areas across the spine from each other depends on the area of the spine which is being treated. In the thoracic and lumbar regions, the distance is between 65 and 80 mm when the manipulating members are in a rest (i.e. non-protruding) position. The distance is measured from a centre of the cap 70 of a manipulating member on a first side region of a bed area to the centre of the cap 70 of a manipulating member on a second side region of the bed area. The centre of each cap corresponds to the centre of the contact area of that manipulating member.

The first and second manipulating members may be spaced apart by a first distance in a direction along the spine, which is transverse to their axial direction of motion. The third and fourth members may also be spaced apart by the same first distance in the same direction along the spine as the first and second members. The first distance may be calculated centre-to-centre between the manipulating members, and may be between 30 mm and 40 mm, more preferably the spacing is 35 mm.

In adjacent pairs of opposed manipulating members in the same manipulating assembly, the distance between manipulating members measured centre-to-centre along the length of the spine between the caps may be the same, even between non-coupled members.

The drive system may comprise a drive assembly for each respective manipulating assembly, each drive assembly comprising: a first actuator for driving a first manipulating member pair; a second actuator for driving a second manipulating member pair; wherein the control system simultaneously activates the first and second actuators to drive respectively the first and second manipulating member pairs. In some embodiments, the drive system can be configured to drive the spinal massage device comprising a number of drive assemblies according to a predetermined program. For example, an actuator may be provided by a motor and lead screw arrangement. Other driving mechanisms including pneumatics or hydraulics may also be used in some examples.

A spring 40 is placed between a pivoting member 45 and the support head 30. The spring allows the assembly to smoothly return to a start or rest position. If the assembly is forward driven, as in FIGS. 1 and 2, and the spring has a high spring constant, the spring 40 could also be used to provide a certain resistance against the members being pushed too hard or too fast into the back of the user, i.e. to provide a degree of protection to the user from overextension of the manipulating members.

In other configurations, not shown in the Figures, the swivel bracket that forms the pivoting member 45 may alternatively be a resiliently deformable block or a ball and socket joint for improving individualised treatment.

In one example of a full cycle of the motor drive, the elongate rod 35 is linearly driven forwards from a resting position by a displacement of about 20 mm in the direction of the user's back then returns backwards to the resting position, aided by the spring 40.

The frequency of the linear movements of the elongate rod caused by the configuration of the motor, the coupling and the lead screw may be between 3 Hz and 6 Hz, more preferably 4 Hz. Manipulation of the tissue of a user resting on the manipulating members preferentially causes relaxation and loosens the vertebral junctions.

The first member 10 and the second member 15 are coupled together at their respective proximal ends by virtue of the pivoting member 45 and are driven as a couple in the same direction and at the same time. The members are arranged such that they address a first side of the spine at adjacent vertebral areas. The pivoting member 45 is a swivel bracket, as shown in FIGS. 1 and 2, arranged to pivot about a centre-point between the first and second members. The pivoting member 45 is supported by a bracket 50, which drives the assembly in response to the actuator and provides a backstop that stops the swivel bracket from pivoting too far. The first and second members may be spaced apart by a distance of about 33.4 mm.

A stopper provides a soft interface between the elongate rod 35 and the pivoting member 45. This allows for a degree of rocking of the members to distribute load evenly on the user's back for individualised treatment and to protect against jolting movements which may be uncomfortable or cause injury or damage the device. The stoppers may comprise rubber grommets, but other similar configurations may be used to provide this effect.

The pivoting member 45, driven by the actuator, is pivoted by a difference in resistance of the manipulating member against the user, caused by a difference in tension or stiffness inherent to the tissue around vertebral junctions. If there is a resulting difference in the force applied to the elongate rods 35 of the first and second members by the interaction between the spine and the manipulating members, a differing range of motion of the adjacent first and second members may be experienced. For example, if the first member 10 is manipulating an area that is particularly stiff or tense, it may have a restricted range of movement compared to a second member 15 that manipulates an area that is less stiff or tense. This will cause the pivoting member 45 to pivot about the central point between the members, such that the range of motion of the second member 15, in synchronicity with the movement of the members by the actuator, is greater than that of the first member 10. The pivoting may be resisted or limited by elastic materials, springs, frictional bearings, etc. to alter the response of the pivoting member 45 to tissue stiffness differentials. This can help ensure that the relative axial motion of a coupled pair of manipulating members 10, 15 is appropriate in response to particular tissue stiffness differentials.

A third manipulating member 20 is positioned on a second side of a vertebral area to the first manipulating member 10, such that they form a pair about the same vertebral area or around a single vertebra. This pair may be advantageously controlled to manipulate the same vertebral area from each side of the spine in a personalised manner, which may be synchronous or asynchronous.

A third manipulating member 20 and a fourth manipulating member 25 are coupled in the same way as the first member 10 and the second member 15 and are arranged to address a second side of the spine across from the first side.

An assembly of the four members addresses both sides of the spine at two vertebral areas, wherein the first and second members are arranged to engage one side and the third and fourth members are arranged to engage the other side; and wherein the first and third members address a first vertebral area and the second and fourth members address a second vertebral area.

The first, second, third and fourth members are assembled in a manipulating assembly 100 as shown in FIGS. 1 and 2. The members are supported and grouped together by the supporting head 30, which forms part of a Y-shaped bracket, comprising a support shaft 85 and the supporting head 30. The angle at which the members manipulate the spine is defined by the Y-shaped bracket, which can be in the range of 40 degrees and 60 degrees preferably where the angle of treatment is 50 degrees relative to the horizontal axis, or equivalently, around 40 degrees to the vertical axis and/or the leg of the Y-shaped bracket.

By virtue of the support head 30, and Y-shaped bracket in general, the number of parts of the assembly is reduced, which beneficially reduces manufacturing time and cost. It also provides a greater surface area of a platform for load bearing of the user.

The supporting head 30 provides a greater surface area for taking the load of the user with respect to the manipulating members, helping to prolong the lifetime of the spinal massage device and providing further comfort to the user. The manipulating members are able to move independently of the supporting head 30 and each other. They are arranged in a square or rectangular configuration and are evenly distributed about the central point of the Y-shaped bracket.

The manipulating members interact with the supporting head 30 which provides positional support but allows the members to move with a degree of freedom in the axis along the centre of the elongate rod 35, for example as shown in the Figures each manipulating member is arranged to slide through a respective aperture in an arm of the Y-shaped bracket.

The support shaft 85 onto which the support head 30 is mounted may be provisioned with a retraction spring and/or a plurality of locking slots 80. A retraction spring may provide greater flexibility of the assembly positioning on the support shaft 85. The plurality of locking slots 80 allows the manipulating assembly to be arranged at a personalised height. Adjacent assemblies may be provided at different heights to adjust for the curvature of the spine. This ensures the manipulating members maintain contact with the vertebral areas of the spine along the full length of the spine to improve the effect of the massaging and may also increase the comfort of the user.

Referring to FIGS. 5 to 7, a pair of opposed manipulating members in accordance with a first manipulating assembly of the spinal massage device of the present invention is described.

A manipulating assembly 200 comprises an assembly including a first manipulating member 210 and a second manipulating member 215, each of which may be configured to engage the spine at a different vertebral area and may each be independently addressable and controllable.

Each of the members in the first manipulating assembly comprises an elongate rod 235, which has a roller 270 mounted at a distal end of the rod, wherein the roller is mounted for rotation about an axis which is perpendicular to the length of the rod.

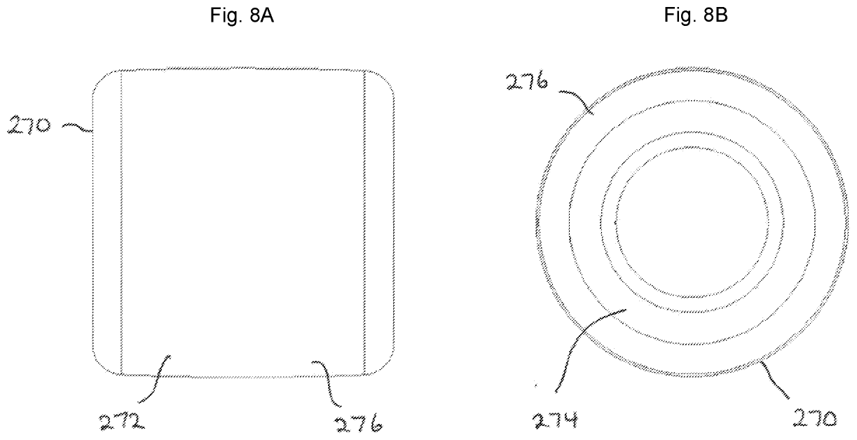

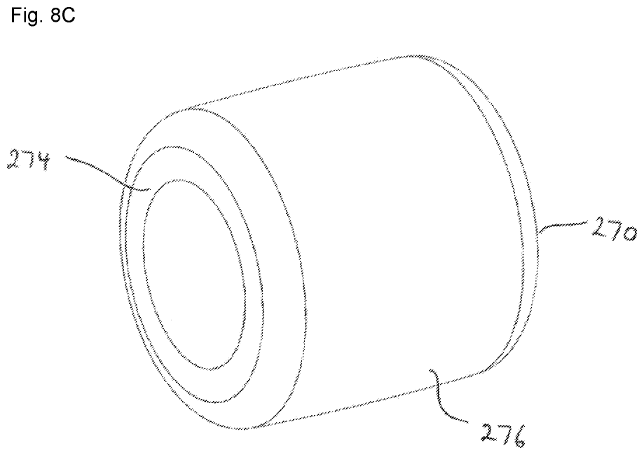

Referring to FIGS. 8A to 8C, roller 270 may comprise a drum 274 with a rubber cover 276.

The rod can be made from a material that is suitably strong and resistant to deformation yet reasonably lightweight, for example a metal such as stainless steel.

In the first manipulating assembly, roller 270 provides the manipulating member with a generally rounded first contact area 272. Roller 270 has the following dimensions: diameter 20 mm and length 20 mm.

The first contact area of each manipulating member of the first manipulating assembly is about 400 mm², calculated using the same measurement method as that used for the fourth contact area, with reference to FIG. 8A.

Rubber cover 276 of roller 270 may have the same hardness properties as caps 70a and 70b of the fourth and fifth manipulating assemblies.

The resilient and deformable properties of roller 270 provide a cushioned interface between the spine and the elongate rod 235. The elongate rod 235 moves linearly along an axis defined along the longer side of the rod, along its centre, the movement being controlled by an actuator comprising a motor 265, a coupling and a lead screw. A lead screw translates the rotational motion of the motor 265 to linear movement, which moves the manipulating member to which it is coupled up and down along the axis of the elongate rod 235 such that the manipulating member penetrates the vertebral area at an angle of 55 degrees to the horizontal defined by the orientation of a supporting head 230.

A distance between the manipulating members shown in FIGS. 5 to 7 is between 60 and 120 mm when the manipulating members are in a rest (i.e. non-protruding) position. The distance is measured from a centre of the roller 270 of a manipulating member on a first side region of a bed area to the centre of the roller 270 of a manipulating member on a second side region of the bed area. The centre of each roller corresponds to the centre of the first contact area of the first manipulating member.

The manipulating members in the first manipulating assembly are supported and grouped together by a supporting head 230 which forms part of a T-shaped bracket 290 comprising a support shaft 285 and the supporting head 230. The supporting head has a first arm 292 and a second arm 294, wherein first arm 292 receives first manipulating member 210 at an oblique angle and second arm 294 receives second manipulating member 215 at an oblique angle.

The angle which rod 235 of first manipulating member 210 makes with a plane of the upper surface 245 of first arm 292 of T-shaped bracket 290 may be between 30 and 80 degrees, preferably 40 to 70 degrees, more preferably 50 to 60 degrees. In one example, this angle is about 55 degrees.

The angle which rod 235 of second manipulating member 215 makes with a plane of the upper surface 245 of second arm 294 of T-shaped bracket 290 may be between 30 and 80 degrees, preferably 40 to 70 degrees, more preferably 50 to 60 degrees. In one example, this angle is about 55 degrees.

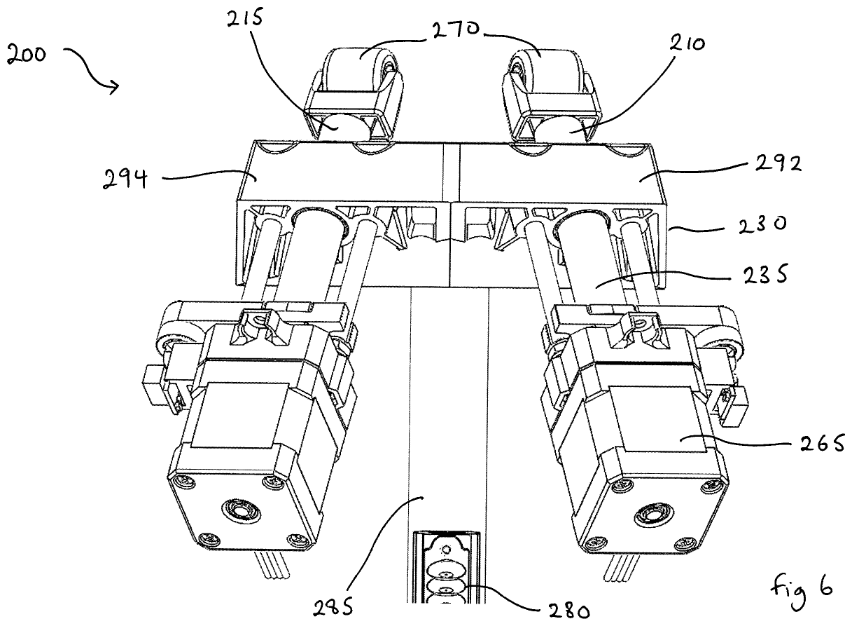

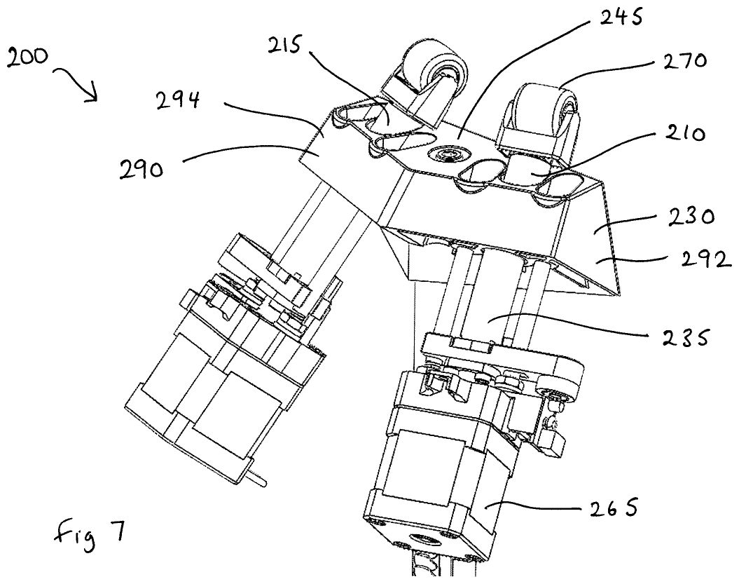

The upper surface 245 of each arm may be coplanar as shown in FIGS. 6 and 7.

The upper surfaces of each arm may be substantially horizonal in use of the spinal massage device.

First manipulating member and second manipulating member are preferably not parallel.

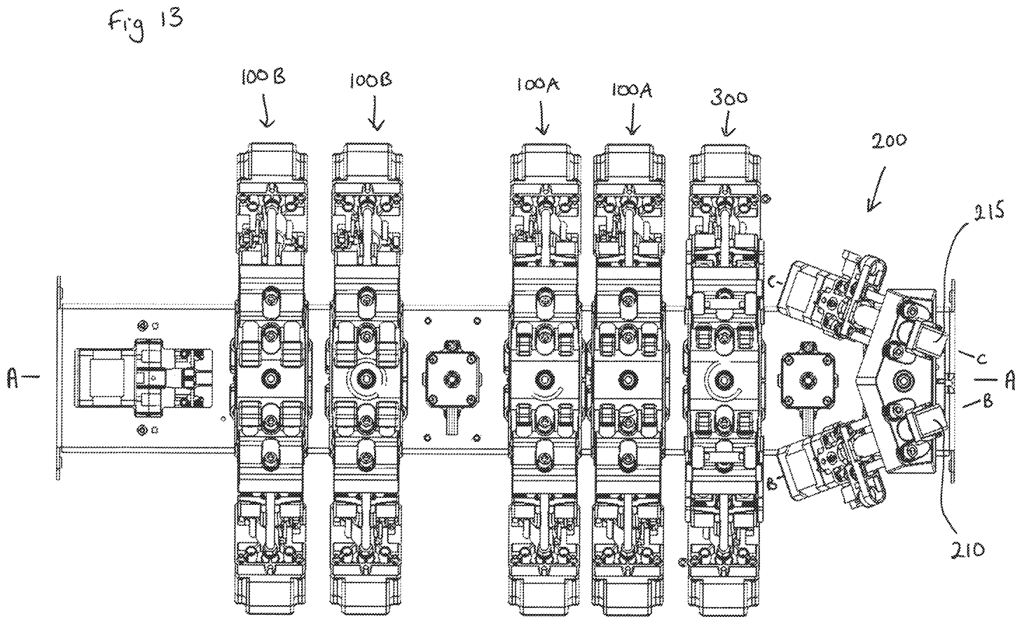

Referring to FIG. 13, in plan view (from above the spinal massage device), axis B-B of the elongate body of first manipulating member 210 makes an angle of about 20 degrees with central axis A-A of the T-shaped bracket, the central axis bisecting the bracket between the first arm and the second arm and being perpendicular to the axis of the vertical portion of the bracket.

In plan view (from above the spinal massage device), axis C-C of the elongate body of second manipulating member 215 makes an angle of about 20 degrees with central axis A-A of the T-shaped bracket.

In use of the spinal massage device, central axis A-A of the T-shaped bracket may extend in the longitudinal direction of the bed area.

The manipulating members of the first manipulating assembly are coupled by the T-shaped bracket but, preferably, are otherwise separate.

By virtue of the support head 230, and T-shaped bracket 290 in general, the number of parts of the assembly is reduced, which beneficially reduces manufacturing time and cost. It also provides a greater surface area of a platform for load bearing of the user.

The supporting head 230 provides a greater surface area for taking the load of the user with respect to the manipulating members, helping to prolong the lifetime of the spinal massage device and providing further comfort to the user. The manipulating members are able to move independently of the supporting head 230 and each other. They are arranged evenly distributed about the central point of the T-shaped bracket.

The manipulating members interact with the supporting head 230 which provides positional support but allows the members to move with a degree of freedom in the axis along the centre of the elongate rod 235, for example as shown in the Figures each manipulating member is arranged to slide through a respective aperture in an arm of the T-shaped bracket.

The support shaft 285 can be mounted as described in relation to the fourth and fifths manipulating assemblies. Support shaft 285 is provided with locking slots 280.

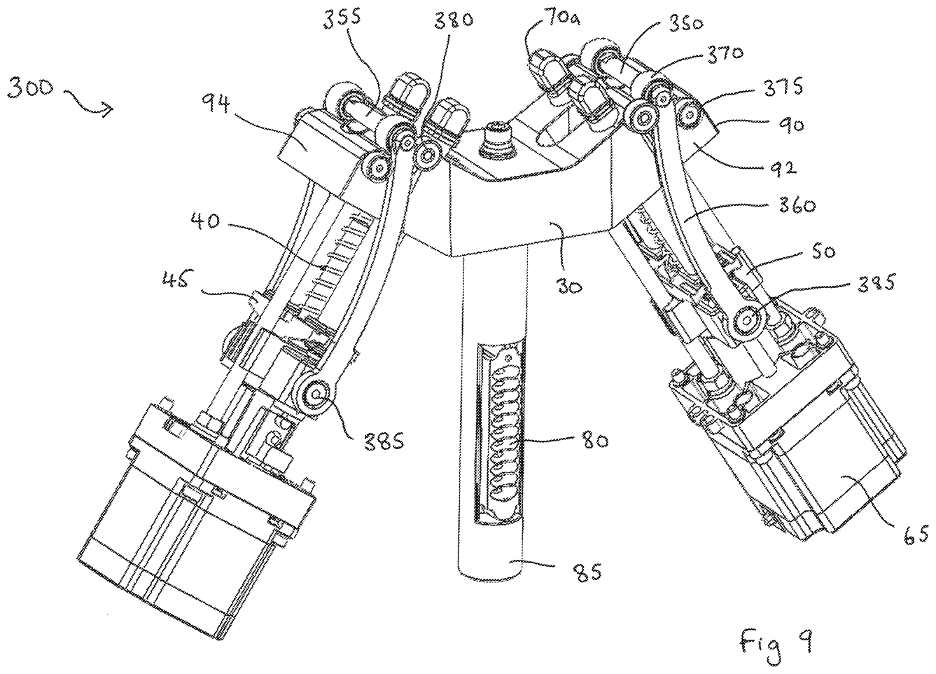

Referring to FIGS. 9 to 11, two pairs of opposed manipulating members in accordance with a second manipulating assembly of the spinal massage device of the present invention is described and two pairs of opposed manipulating members in accordance with a third manipulating assembly of the spinal massage device of the present invention is described.

The second and third manipulating assemblies provide a unitary manipulating assembly 300 in this embodiment of the present invention.

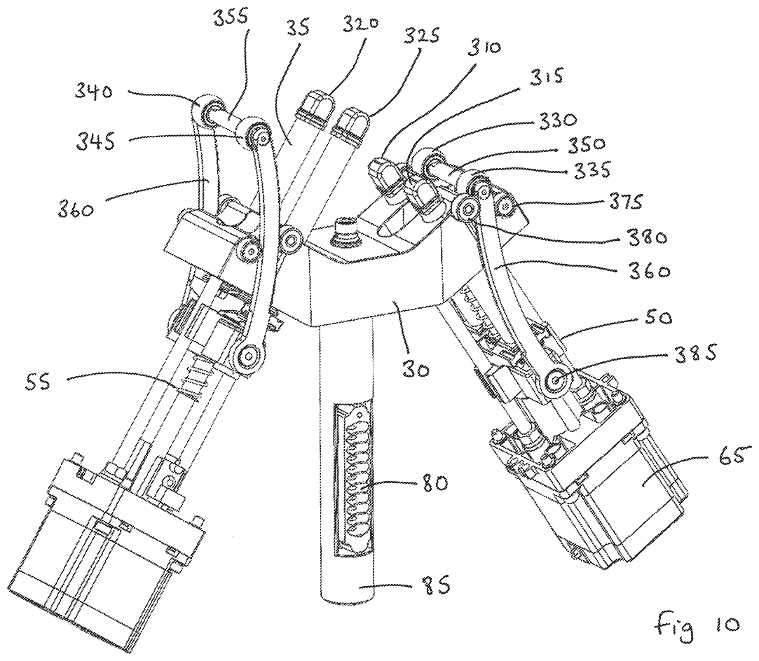

Referring to FIGS. 9 and 10, the second manipulating assembly comprises a first manipulating member 330, a second manipulating member 335, a third manipulating member 340, and a fourth manipulating member 345, mounted together. First manipulating member 330 is coupled to second manipulating member 335 and third manipulating member 340 is coupled to fourth manipulating member 345 at their respective distal ends. Each coupled set of manipulating members may be configured to engage a shoulder blade area of a user's back and may each be independently addressable and controllable.

Each of the manipulating members in the second manipulating assembly comprises an arcuate arm 360 having a proximal end which is pivotally mounted on bracket 50 at pivot point 385 and a distal end on which is pivotally mounted a roller 370, wherein the roller is mounted for rotation about an axis.

First manipulating member 330 is coupled to second manipulating member 335 at their respective distal ends by their respective rollers being mounted for rotation on a common drum 350.

Third manipulating member 340 is coupled to fourth manipulating member 345 at their respective distal ends by their respective rollers being mounted for rotation on a common drum 355.

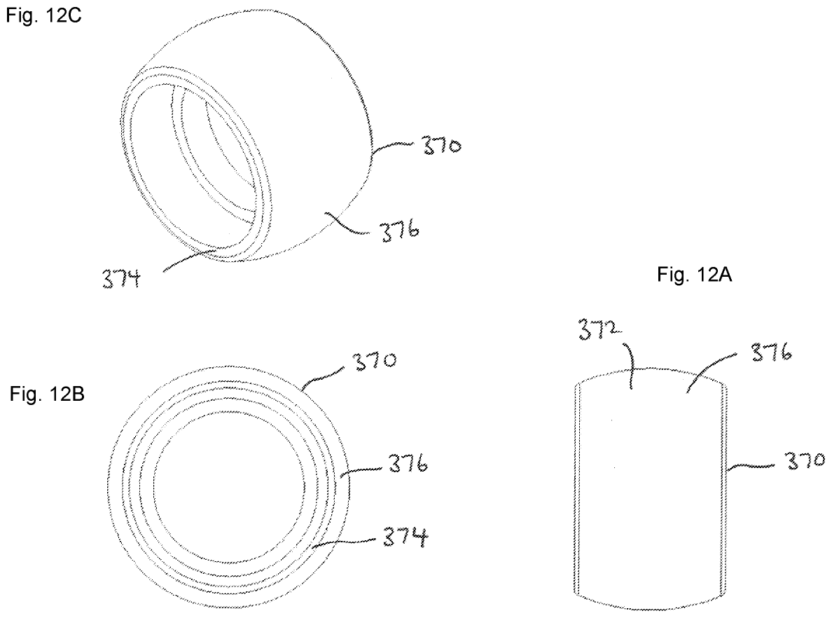

Referring to FIGS. 12A to 12C, roller 370 may comprise a drum 374 with a rubber cover 376.

Arcuate arms 360 and drums 350, 355 can be made from a material that is suitably strong and resistant to deformation yet reasonably lightweight, for example a metal such as stainless steel.

In the second manipulating assembly, roller 370 provides the manipulating member with a generally rounded first contact area 372. Roller 370 has the following dimensions: diameter 16 mm and length 10 mm.

The second contact area of each manipulating member of the second manipulating assembly is about 160 mm², calculated using the same measurement method as that used for the fourth contact area, with reference to FIG. 12A.

Rubber cover 376 of roller 370 may have the same hardness properties as caps 70a and 70b of the fourth and fifth manipulating assemblies.

The resilient and deformable properties of roller 370 provide a cushioned interface between the spine and arcuate arm 360 and between the spine and the common drum 350, 355.

The third manipulating assembly comprises a first manipulating member 310, a second manipulating member 315, a third manipulating member 320, and a fourth manipulating member 325, mounted together, each of which may be configured to engage the spine at a different vertebral area and may each be independently addressable and controllable.

Each of the manipulating members in the third manipulating assembly comprises an elongate rod 35, which has a cap 70a. The properties and configurations of rod 35 and cap 70a are in accordance with those of rod 35 and cap 70a of the fourth manipulating assembly.

The description of the configuration and operation of the fourth manipulating assembly applies to the third manipulating assembly.

In addition, since the second and third manipulating assemblies provide a unitary manipulating assembly 300, the manipulating members of the third manipulating assembly are positioned laterally inside the manipulating members of the second manipulating assembly at substantially the same position along the longitudinal axis of the bed area. The manipulating members of the third manipulating assembly are therefore located closer to the longitudinal axis in a lateral direction than the manipulating members of the second manipulating assembly.

In this regard, manipulating member 310 of the third manipulating assembly is adjacent and laterally inside of manipulating member 330 of the second manipulating assembly in the lateral direction; manipulating member 315 of the third manipulating assembly is adjacent and laterally inside of manipulating member 335 of the second manipulating assembly in the lateral direction; manipulating member 320 of the third manipulating assembly is adjacent and laterally inside of manipulating member 340 of the second manipulating assembly in the lateral direction; and manipulating member 325 of the third manipulating assembly is adjacent and laterally inside of manipulating member 345 of the second manipulating assembly in the lateral direction.

Arcuate arms 360 of the second manipulating assembly are each supported between an outer roller 375 and an inner roller 380 mounted on a respective first arm 92 or second arm 94 of the Y-shaped bracket 90. With reference to FIGS. 9 to 11, these inner and outer rollers guide the arcuate arms during use of the spinal massage device to provide a general arcuate movement of each second contact area in a lateral direction as the opposed manipulating members of the second manipulating assembly are raised.

Bracket 50 is common to the second and third manipulating assemblies meaning that the opposed manipulating members of the second manipulating assembly are raised in tandem with the opposed manipulating members of the third manipulating assembly.

FIG. 9 shows the manipulating members of the second and third manipulating assemblies in a rest position: the manipulating members of the second manipulating assembly and the manipulating members of the third manipulating assembly are closest together at this stage.

FIG. 10 shows the manipulating members on one side of the Y-shaped bracket being raised: the manipulating members of the second manipulating assembly are raised with the manipulating members of the third manipulating assembly: the positions of the distal ends of the manipulating members of the second manipulating assembly and the manipulating members of the third manipulating assembly diverge as the manipulating members of the second manipulating assembly move along an arc away from a direction along the length of support shaft 85 (being an axial direction of the support shaft) and the manipulating members of the third manipulating assembly move towards this axial direction.

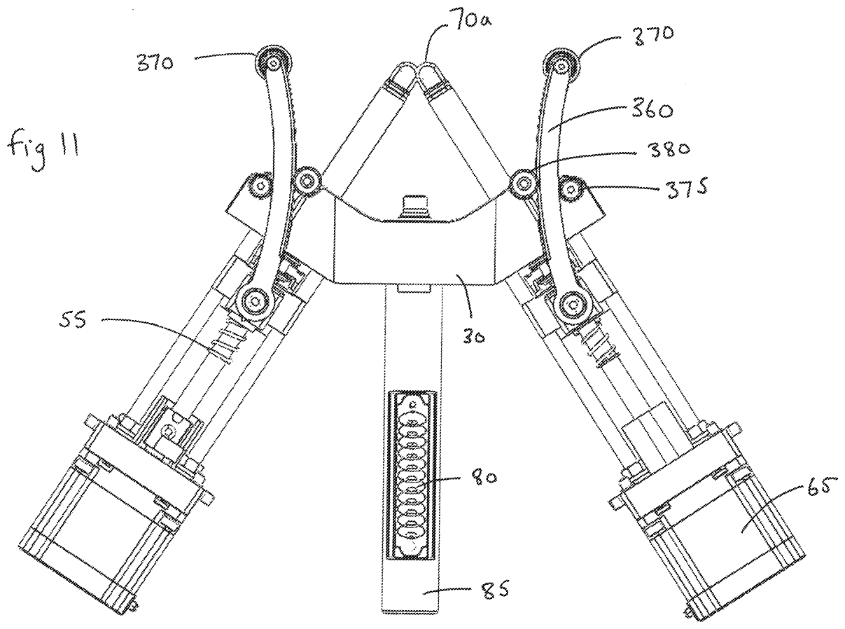

FIG. 11 shows the manipulating members on both sides of the Y-shaped bracket fully raised: the manipulating members of the second manipulating assembly are raised with the manipulating members of the third manipulating assembly: the positions of the distal ends of the manipulating members of the second manipulating assembly and the manipulating members of the third manipulating assembly reach a maximum spacing as the manipulating members of the second manipulating assembly move along an arc away from a direction along the length of support shaft 85 (being an axial direction of the support shaft) and the manipulating members of the third manipulating assembly move towards this axial direction; the manipulating members of the third manipulating assembly may abut in the axial direction of support shaft 85 at this stage.

Locking slots 80 and 280 can have a number of increments for individualised user experience. Configurations with greater or fewer numbers of increments are also possible. The slots are designed to be angled so that the locking plate that connects with the slot pushes inwards and upwards to maintain a connection with the user's back during locking. The edges of the locking slots are angled to allow smooth and controlled entry of height setting pins to avoid sharp or jolting movements.

For different regions of the spine, the support shaft has different lengths. Where the manipulation assembly interacts with the neck, for example in the cervical region of the spine, the support shaft 285 has a length longer than the length of the support shaft 85 along the upper and lower back, for example the thoracic and lumbar regions. For example, the support shaft 285 in the neck region may have a length of 217.5 mm and the length of the support shaft 85 in the upper and lower back regions may be 177.5 mm. The diameter of the support shaft 85, 285 may be 25.1 mm, and it may have a D-shaped cross-sectional area that is shaped to prevent rotation of the support head 30, 230. It will be appreciated that other dimensions and configurations may be possible.

The support shaft 85, 285 may also provide a means for rotation of the manipulating assembly to provide further personalisation for users with spinal curvature.

The elongate rod 35, 235 has a circular cross-section, however, it may be configured to be D-shaped, at least slightly, to prevent it from rotating about the axis along which it moves.

Other configurations of the assemblies arranged by the support head 30, 230 may be possible, such as assemblies configured to constrain more than or less than the number of manipulating members described above for each manipulating assembly.

The drive system can be adapted to drive manipulating members on the first side of the spine out of phase with manipulating members on the second side of the spine, or to drive the manipulating members on the first side of the spine and manipulating members on the second side of the spine in antiphase with one another. In other embodiments, the manipulating members may be driven in phase or both in anti-phase and in phase throughout a massage routine, for varying durations, which may be more effective than driving the members consistently at the same phase. The drive system can drive the manipulating members with a constant cycle time or with a varying cycle time between the different members and can be configured to control assemblies individually and/or in combination with other assemblies, for example, according to a pre-determined program of the spinal massage device.

FIG. 13 illustrates an array of manipulating assemblies arranged such that they are able to be positioned along the length of a longitudinal axis of a bed area of a spinal massage device. Manipulating assemblies 100, 200 and 300 are shown.

Manipulating assembly 100A is the fourth manipulating assembly; manipulating assembly 100B is the fifth manipulating assembly; manipulating assembly 200 is the first manipulating assembly; and manipulating assembly 300 is the unitary second and third manipulating assemblies.

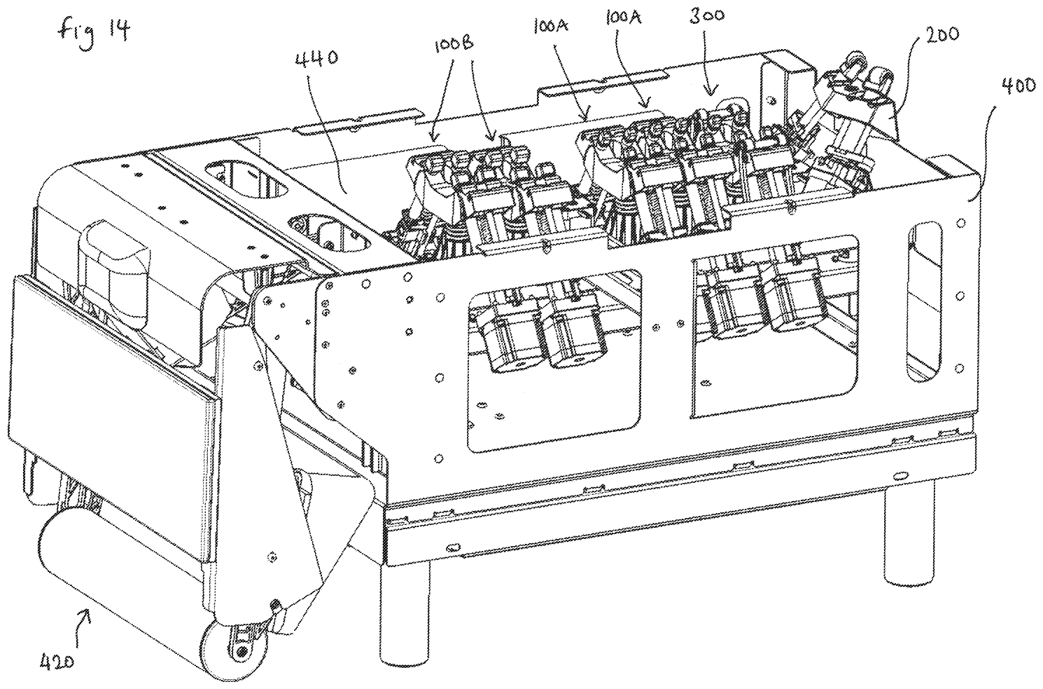

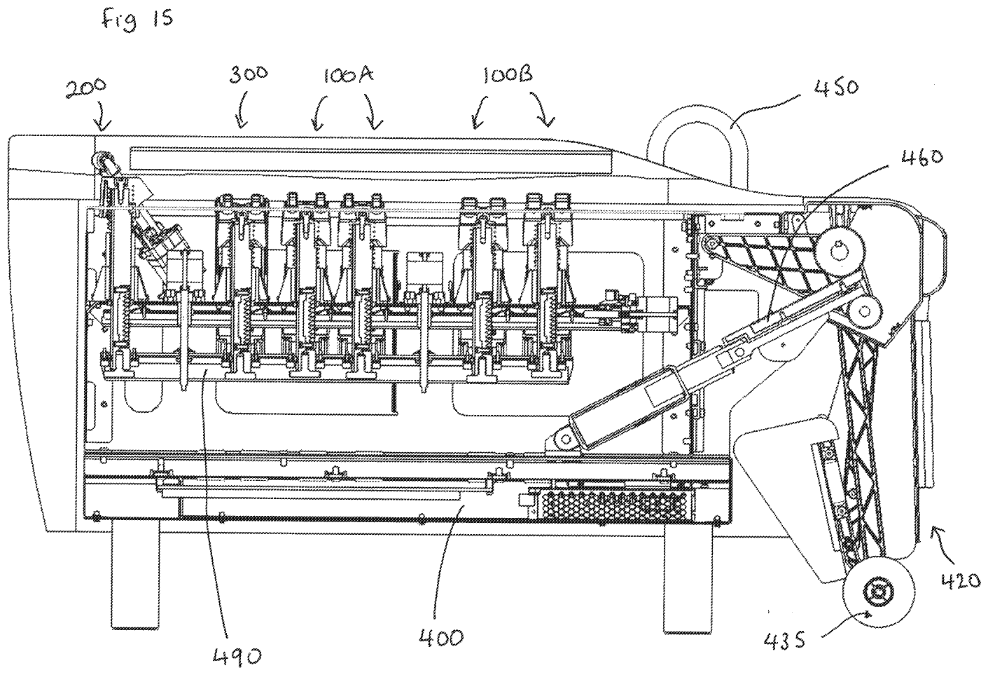

FIGS. 14 and 15 illustrate this array of manipulating assemblies mounted on a chassis 490 in a frame 400. The manipulating assemblies are arranged on the chassis 490 in groups that correspond to different areas of the spine, namely the cervical, thoracic and lumbar vertebral regions.

The cervical region of the spinal massage device comprises the first manipulating assembly which comprises two manipulating members; the thoracic region and the shoulder blade area comprise the second, third and fourth manipulating assemblies; and the lumbar region comprises the fifth manipulating assembly,

In this embodiment, the second manipulating assembly comprises four manipulating members; the third manipulating assembly comprises four manipulating members; the fourth manipulating assembly comprises eight manipulating members; and the fifth manipulating assembly comprises eight manipulating members.

The spacing of the manipulating assemblies in each spinal region is greater than the spacing of the manipulating members in each manipulating assembly. Preferably, the spacing between groups is 105 mm in one example. The spacing of manipulating members in an assembly in a single group is less than this and is about 35 to 45 mm in one example.

Referring to FIGS. 14 and 15, the frame 400 comprises a bed structure where the user lies down face up on their back, and a movable leg support 420 supports a user's legs. The portion of the bed structure onto which the user lies is designed in a V-shape with an aperture 440 at the base of the V through which the spinal massage device operates.

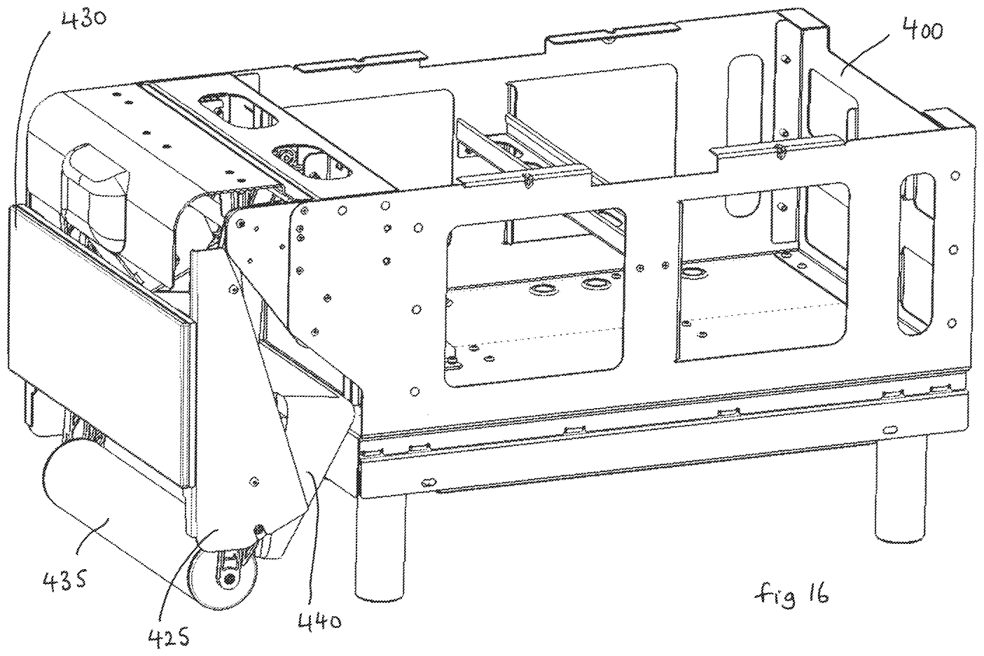

Referring to FIGS. 16 to 18, a leg support 420 may be set at a halfway point or fully extended depending on the preference of the user. In some cases, the leg support may be used to position the user's spine in a particular way, and in this way can form part of the operation of the device in providing a massage routine.

Prior to use of the spinal massage device, leg support 420 is in a lowered position for storage as shown in FIG. 16.

Leg support 420 comprises a pair of side arms 425 mounted for rotation at or towards the bottom region of the bed area: the axis of rotation of the or each side arm is substantially perpendicular to the longitudinal axis of the bed area. Each side arm is mounted for rotation on frame 400 at or towards a proximal end of the side arm.

In a fully lowered position, each side arm 425 of leg support 420 generally extends in a vertical direction below the level of the bed area.

In a semi-raised position, when leg support 420 is at a halfway point, each side arm 425 is rotated outwardly by approximately 90 degrees from the fully lowered position.

In a fully elevated position, each side arm 425 is rotated outwardly by approximately 180 degrees from the fully lowered position.

Leg support 420 also comprises a first member 430, a second member 435 and a third member 440 which is provided with a foot rest 445.

First member 430 is mounted between the proximal and distal ends of side arms 425 and spans the distance between side arms 425.

Second member 435 is mounted for rotation between side arms 425, at or towards distal ends of the side arms, and comprises a roller mounted for rotation along an axis which is parallel to the axis of rotation of side arms 425.

Third member 440 is mounted between side arms 425, at or towards the distal ends of the side arms.

Second member 435 is positioned between first member 430 and third member 440 in the longitudinal direction of the bed area: first member 430, second member 435 and third member 440 all extend in the lateral direction.

Referring to FIG. 16, in a fully lowered position, each side arm 425 of leg support 420, together with first member 430, generally extends in a vertical direction below the level of the bed area. Third member 440 is in a folded position for storage beneath first member 430. Of all the three members of leg support 420, second member 435 is located lowermost.

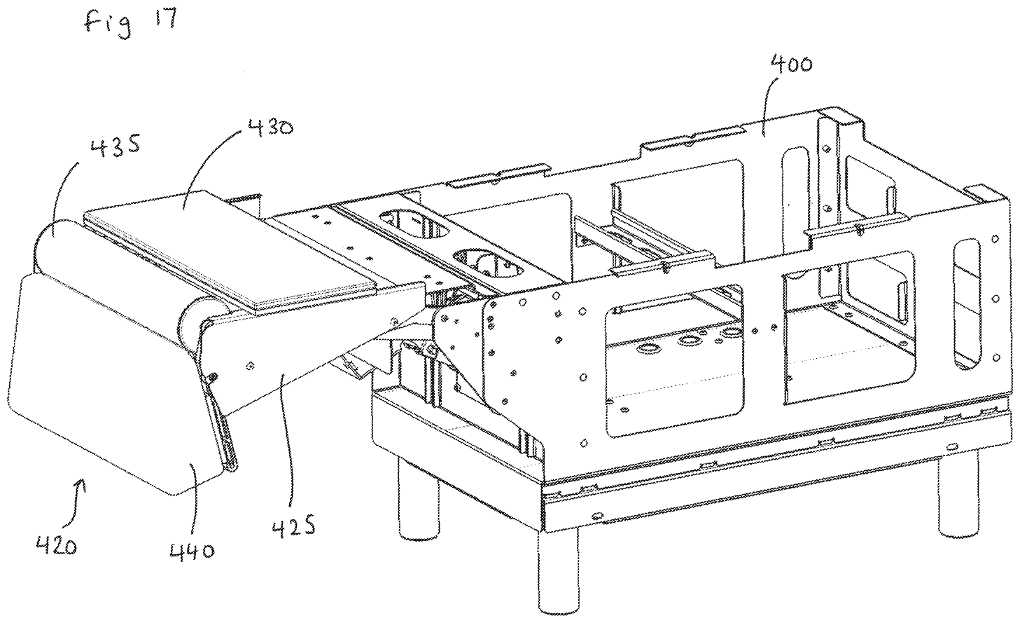

Referring to FIG. 17, in a semi-raised position, when leg support 420 is at an approximate halfway point, side arms 425 are rotated outwardly by approximately 90 degrees from their fully lowered position. First member 430 is supported by the side arms in a generally horizontal position at a level which approximately matches the level of the bed area. Third member 440 is in an unfolded position and generally extends in a vertical direction below the level of the bed area.

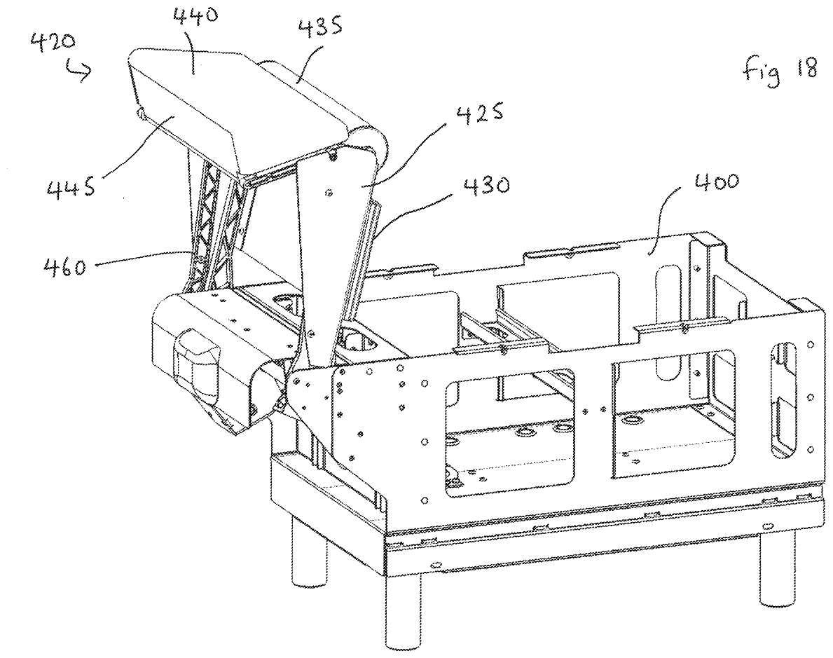

Referring to FIG. 18, in a fully elevated position, side arms 425 are rotated outwardly by approximately 180 degrees from their fully lowered position. First member 430 is supported by the side arms in a generally vertical position above the level of the bed area. Third member 440 generally extends in a horizontal direction above the level of the bed area.

Side arms 425 are rotated outwardly by approximately 180 degrees from the fully lowered position of leg support 420 to the fully raised position of leg support 420.

Leg support 420 is raised and lowered using an extension mechanism such as a gear system. In the fully lowered position, leg support 420 is stored beneath the bed area, at least in part, to provide a compact spinal massage device.

Leg support 420 is arranged to be raised and lowered at either constant, variable or adjustable speeds.

In one example, the speed of raising and/or lowering leg support 420 reduces at or towards the end of its movement to prevent a user's fingers becoming trapped.

In the present embodiment, the leg support 420 has a leg support actuator 460 configured to move the movable leg support progressively controllably into a raised or a lowered position and a controller is arranged to control the leg support via the leg support actuator.

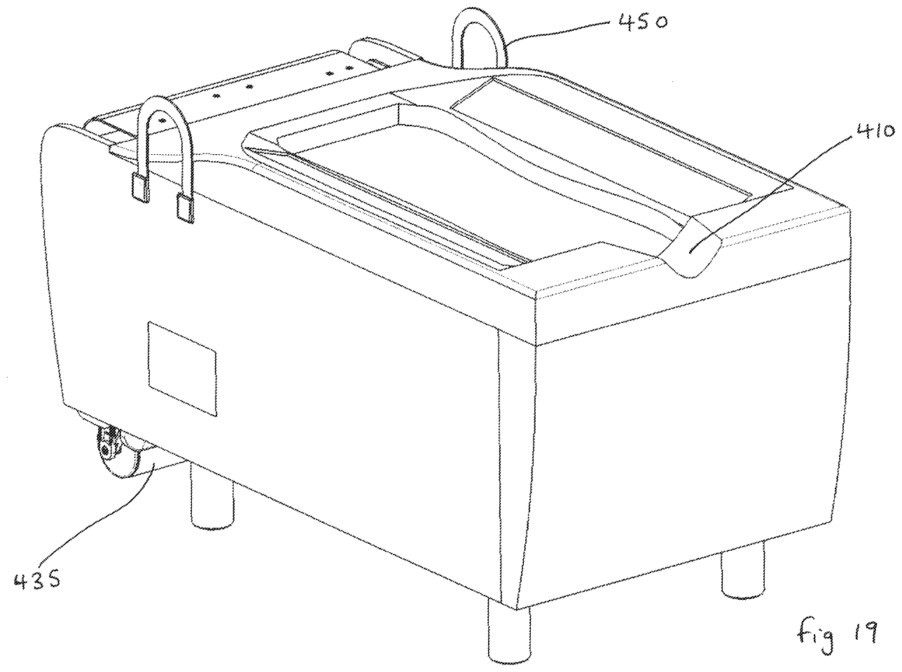

The spinal massage device is arranged with a head support 410 that is integral to the bed as shown in FIG. 19, although other configurations are also possible. Further support, for example to support the dorsal or lumbar back areas, may also be used. Handles 450 may be provided to assist a user, particularly when dismounting from the bed area.

The portion of the bed structure on which the user lies has an opening or aperture 440 that exposes the back to the manipulating members of the spinal massage device. This portion of the bed structure is covered, as shown in FIG. 19, such that there is an additional cushioning layer between the manipulating members and the spine, the user is presented with a flat, bed-like surface on which to lie down and the manipulating members themselves do not make direct contact with a user's skin. The angle of the aperture 440 is designed for comfort by cradling a user's back.

Dimensions of the frame 400 are preferably 500 mm high×560 mm wide×1265 mm long. These dimensions are suitable for transportation and manoeuvrability through doors and passageways. Other dimensions may be used to suit users who are particularly small (children for example) or particularly tall.

Reduction of the noise and vibration of the bed during a massage is prevented by spacers, which may preferably be made of rubber. The spacers decouple the plate holding the motors from the rest of the chassis 490. In some cases, as shown in FIGS. 1 and 2, the actuators for driving the manipulating members are “floating” relative to the chassis 490. That is to say, they are not mounted on the chassis 490, so do not directly transfer vibrations to the chassis 490. In some cases, mechanical dampers can be included on the transmission path for mechanical vibrations. This can help to further reduce vibration transfer.

A massage routine comprises a method to be executed by the spinal massage device. Individual manipulating members are addressed by the actuator, which causes them to move forwards and backwards in a linear motion. The linear motion produces a force into the user's back in the region of the spine that it engages. This force can be tailored, for example, by the surface area of the manipulating member or the speed with which it is driven. Sufficient force is provided to drive the manipulating member into the user's back with a massaging effect without causing damage.

Examples of massage routines and tailoring may include:
(1) Area of focus. The amount of time of a massage routine spent, for example, focussing on a particular area of the spine, e.g. the neck. In some examples, a massage routine could spend twice to three times longer on the neck than it does on upper back and/or lower back.
(2) Speed of the manipulating members: fast movements are felt by a user as being more ‘intense’ compared to slow movements which are perceived to be more ‘gentle’.

(3) Intensity: ranging from 0 to 10 that represents a fraction of how far each of the
manipulating members move toward the corresponding treatment area from a neutral starting position and controls depth of massage into the spine.
(4) Massage routine duration: ranging from around 5 minutes to about 40 minutes, depending on personal needs, time to spare, etc.

As an example, some specific massage routines may focus on the lower back, for example for treating sciatica or vertebral disc problems. Other programmes may be designed for treating headache, arm or shoulder pain caused by trapped nerve(s) around the neck and shoulder, by focussing on the neck and/or upper back region. In this context, “focus” may for example include the manipulating members in the region of focus: spending more time manipulating a particular spinal region; exerting more force while manipulating a particular spinal region; moving a larger distance while manipulating a particular spinal region; and/or moving faster while (relative to the regions which are not regions of focus).

Two manipulating members may be driven as a pair about a vertebra. The members can be manipulated individually to create a variety of massaging effects. The members can be driven in synchronous motion, for example, by being driven forwards and backwards at the same time to create a squeezing effect. They can also be driven in asynchronous motion such that one moves forwards as the other moves backwards. It will be appreciated that other motions between synchronicity and synchronicity can be performed. Typically, the cycle time of each manipulating member (time taken for a member to move forwards and backwards and return to the starting position) is constant such that the phase of the motion of the members is constant, though it does not have to be. Massage routines may comprise a mixture of massaging effects created by the manipulating members in a number of sequences.

Pairs of manipulating members are configured in the second to fifth manipulating assemblies such that two pairs address adjacent vertebrae. Members that are adjacent one another along the length of the spine are configured to be driven together. Members in assemblies are therefore typically driven to act as two pairs, so the massaging effect applied to a first pair is simultaneously applied to the second pair.

Assemblies can be driven with the same massaging effect along the length of the spine or with different effects. A rippling effect along the length of the spine can be developed by driving assemblies with the same cycle length and massaging effect at different starting points in the cycle. Other effects, such as a rocking motion, can be achieved by driving members on each side of the spine asynchronously. Twisting or zig-zag motions can also be created by assemblies in groups at the lumbar and cervical regions being driven in anti-phase with assemblies in the thoracic region. Different regions can experience different massaging effects where it is appropriate for individual users.

Machine learning techniques analyse data and automate analytical models. It is a branch of artificial intelligence based on the idea that systems can learn from data, identify patterns and make decisions with minimal human intervention. However, human intervention can be used to overrule machine learning decisions where appropriate. The machine learning can be performed across a large cross-section of users of the spinal massage device. Maintaining anonymity can be prioritised, and secure measures implemented to ensure user confidentiality. However, metadata can be used to very quickly determine effective massage routines and learn efficient ways to treat users.

Parameters of the apparatus and method described above which can be altered in such learning techniques include: spacings and distances between manipulating members in assemblies and in different groupings (for example arranged according to a user's height), force with which to drive the manipulating members, tilt of the manipulating members controlling the angle of manipulation the spinous area of a user, height of the footrest, massage routines including synchronisation of movement of manipulating members in different assemblies and/or on different sides of the spine, total length of treatment or lengths of particular stages or cycles within the treatment, distance of manipulating member to travel in one movement (which may change, or dynamically change, throughout a treatment), operating speed of a manipulating member (which may also change throughout a treatment); motions (e.g. ripple, twist, squeeze, rock) to be performed throughout the treatment and, optionally, instructions on how to achieve these motions using the plurality of manipulating members; duration and sequences of motions; force/pressure to be applied to the spine; and/or other parameters which can be controlled by a central unit or control system. Each of these parameters can be varied by the controller as part of an iterative learning experience. Further input such as measurements of force exerted (via current or voltage draw as set out below); measurement of actual extension as compared with the extension intended to be implemented by the controller; or even user satisfaction (or dissatisfaction) feedback can be used to allow the model to self-identify whether the changes were effective in improving the massage routine for that particular user. When aggregated, this learning can be extremely useful in guiding the development of highly tailored treatment programs for new or existing users.

Machine learning and artificial intelligence can be used to improve the user experience and the effectiveness of the treatment. During a treatment, manipulating members move up and down along their axis by an amount determined by a control signal, for example the electrical current imparted by a motor coupled to each manipulating member (or group of members), and a different intensity felt by a user can be achieved based on the range of movement along the axis. This data can be used to model the behaviour of a massage routine. An example of a model that can be used to determine a massage routine is detailed below.

Training can be performed using the following steps. People with pains in different areas of the spine (upper, middle and lower back) are found and participate in a number of sessions until the best settings are found for their specific needs. Whether or not a particular motion has been appropriate can be determined (and fed back into the training model to verify the selection of motions, or suggest that a different motion be tried next time) by any suitable method. For example, users may self report satisfaction with the motion of the manipulating members (either continuously during treatment, or in general at the end of a session, over their whole spine, or in particular areas, etc.—the reporting can be as fine grained as desired). In other cases, the relationship between strength of control signal (e.g. current supplied to a motor) and the force exerted, the distance moved, the speed of motion, etc. can be used to infer whether the treatment provided by the manipulating members was appropriate for the particular tissue being manipulated, on a per-manipulating-member basis.

Indeed, the machine learning process can even learn from a user over multiple sessions. For example, tissue of a particular stiffness may become gradually relaxed over several sessions. In the training phase, the machine learning algorithm may be informed of the change in tissue stiffness (or other parameter(s)) over time as a user recovers from a particular condition. By inferring the relevant parameter(s) from the dynamics of the manipulating members as discussed above, the machine learning process can infer how far along the treatment is, and cause the manipulating members to make appropriate motions for that stage of the treatment. This process can also be used to feedback to the model, for further refinement, for example where a user is not responding as expected, alternative profiles may be implemented. The success or failure of these for improving the user's condition can be used to guide future treatments for other users.

Data is collected throughout the sessions concerning the electric currents and individual motor movements. Electrical current for N motors is denoted as X={X1, X2, . . . , XN} and the manipulating member position is denoted as Y={Y1, Y2, . . . , YN}, the AI model is a function Y=f(X). The function, f, is a recurrent neural network model that has the ability to observe the sequence of X over time such that it can make predictions and deliver the most appropriate treatment for a user.

The model is represented by a set of matrices W and hidden states h. At each time step, the model is given the input electrical current, X, and the output label, Y, then, using a neural network optimisation algorithm (e.g. ADAM, SGD, etc.), the matrices W are adapted to an optimal value.

Inference can be performed using the following steps. The system takes the electrical currents as input and predicts which part of the body is having a problem and from that, the system can deliver the most suitable massage routine for the user.

In some embodiments, additional parameters can be monitored, for example to learn when to stop driving the manipulating members into the spine. As the manipulating members push against the tissue, the current reading increases steadily for a short period of time before spiking when they manipulate and deform the tissue and press against the bony mass of the spine. This is illustrated by the sudden change in gradient in the graph of FIG. 11, which plots current against time for one cycle of the movement of the members. The motors driving the manipulating members require more current to push through more dense/higher tension tissue than soft/relaxed tissue. When plotted on an axis of current against time, the point at which the spike appears should decrease with time across the therapy session, indicating that the tissue is loosening. Monitoring the current feedback can be performed and utilised by machine learning techniques. Learning where the threshold or boundary between hard and soft tissue lies can be used in a number of scenarios.

The point just before a significant increase in gradient, as shown on the graph in FIG. 12 is indicative of a boundary between hard and soft tissue and can be learnt. By learning when in the cycle the change in gradient is going to happen, hitting bony mass can be avoided, which prevents injury or discomfort to the user. These measurements could be used to determine effectiveness of a massage routine and machine learning used to alter the program accordingly.

Machine learning can be used for personalising individual treatments or for creating more generic massage routines. Personalisation can be in one or more of the following areas:

### 1) Treatment Area

Given electrical current values for each motor, the model can predict the stiffness of the different areas of the back. It is believed that the harder the back, the more electrical current is needed to deliver a constant speed of movement of the manipulating members.

### 2) Treatment Intensity and Duration

Given the stiffness predicted, artificial intelligence and machine learning can predict from its training data that a particular stiffness level indicates a certain level of intensity should be used as has been trained from users who participated in training data.

For example, consider a sample of two users. A first user has a first stiffness of upper back of 8 out of 10 and during a massage, the first user often chooses a level of intensity of 5 out of 7. A second user has a similar stiffness of upper back, for example 7 out of 10, and the second user often chooses the level of intensity of 4 out of 7. This gives the AI training samples: 8:5, 7:4. A generalised model can be built on these results, including a number of additional results, that can be used to determine a massage routine given any stiffness level, and any other factors such as users weight for example, and predict an appropriate intensity level for that user.

Treatment duration follows the same principle as the intensity learning.

A general library database can be created that stores group data such as applied control settings and measured thresholds, which can be used to inform future massage routines. For example, measuring where the hard-soft tissue boundary is likely to occur can be used to pre-set the positioning of physical parameters (e.g. the range of extent of manipulating members, their optimal angle of operation or geometric positioning within an assembly) and operating parameters (e.g. applied force, synchronicity of motion or session length). Group data may be used to, for example, generate informed massage routines for new users, which may provide a starting platform that can be personalised as treatment is undergone.

Treatment settings of individual users may be stored and saved such that treatment sessions can both be planned according to individual needs and monitored to determine progression made over a series of treatment sessions. User specific details may be stored and accessed from a user library, which may be configured to automatically apply certain features before beginning a new treatment session (such as operating force/power or previously determined control variable thresholds),

Particular conditions may prove to show particular traits in back stiffness or respond in a predictable way to treatment sessions. Collecting and analysing data from each treatment session may be used to create a series of tailored, selectable massage routines, which are continuously modified and improved as more treatments are performed. For example, if it is determined that rippling motions are more successful at treating particularly stiff areas of the back compared to synchronous motions, massage routines may be suitably adapted to reflect this.

Remote diagnosis can also be performed from data collected during treatment, for example, from the current drawn by different components of the system. Such remote diagnosis may be used to select a pre-generated massage routine from a library of selectable profiles. The library may contain profiles that have been created using machine learning techniques, ready-made profiles, or a mixture of both.

Within this specification, references to moving into contact mean moving such that palpable force or pressure is transmitted.

It will be appreciated from the above description that many features of the different examples are interchangeable with one another. The disclosure extends to further examples comprising features from different examples combined together in ways not specifically mentioned. Indeed, there are many features presented in the above examples and it will be apparent to the skilled person that these may be advantageously combined with one another.

1-31. (canceled)

32. A spinal massage device comprising:
a bed area arranged in use for a user to lie in a substantially horizontal supine position, the bed area defining a longitudinal axis arranged to lie substantially along a user's spine and extending in a longitudinal direction from a head region to a bottom region of the bed area, the bed area having opposed side regions each extending outwards in a lateral direction from the longitudinal axis, wherein a vertical direction is substantially perpendicular to the lateral direction and extends into and out of the bed area;
a head support area provided at the head region of the bed area and arranged in use to support at least a portion of the weight of a user's head when lying face-upwards on the bed area;
a movable leg support provided at the bottom region of the bed area and arranged in use to raise to an elevated position to support a user's legs at a level above the level of the bed area and to lower for storage or access,
a first manipulating assembly comprising at least a first pair of opposed manipulating members substantially symmetrically disposed about the longitudinal axis, each manipulating member having a generally rounded first contact area in use and having a first set of actuators configured to move the manipulating members of the first manipulating assembly progressively controllably into or away from engagement with a cervical region of a user's spine which movement includes at least a final substantially linear reciprocal translation movement whereby during at least a portion of the movement the first contact areas of the pair of opposed manipulating members move closer together as the pair of opposed manipulating members are raised;
a second manipulating assembly comprising at least a second pair of opposed manipulating members substantially symmetrically disposed about the longitudinal axis, each manipulating member having a generally rounded second contact area in use and having a second set of actuators configured to move the manipulating members of the second manipulating assembly progressively controllably into or away from engagement with a user's shoulder blade area which movement includes at least a portion of generally arcuate movement of each second contact area in a lateral direction as the opposed manipulating members are raised;
a third manipulating assembly comprising at least two third pairs of opposed manipulating members substantially symmetrically disposed about the longitudinal axis, each manipulating member having a generally rounded third contact area in use and having a third set of actuators configured to move the manipulating members of the third manipulating assembly progressively controllably into or away from engagement with a thoracic region of a user's spine which movement includes at least a final substantially linear reciprocal translation movement whereby during at least a portion of the movement the third contact areas of each pair of the opposed manipulating members move closer together as the pair of opposed manipulating members are raised and wherein the manipulating members of the third manipulating assembly are positioned laterally inside the manipulating members of the second manipulating assembly;
a fourth manipulating assembly comprising at least three fourth pairs of opposed manipulating members substantially symmetrically disposed about the longitudinal axis, each manipulating member having a generally rounded fourth contact area in use and having a fourth set of actuators configured to move the manipulating members of the fourth manipulating assembly progressively controllably into or away from engagement with the thoracic region of a user's spine which movement includes at least a final substantially linear reciprocal translation movement whereby during at least a portion of the movement the fourth contact areas of each pair of the opposed manipulating members move closer together as the pair of opposed manipulating members are raised;
a fifth manipulating assembly comprising at least four fifth pairs of opposed manipulating members substantially symmetrically disposed about the longitudinal axis, each manipulating member having a generally rounded fifth contact area in use and having a fifth set of actuators configured to move the manipulating members of the fifth manipulating assembly progressively controllably into or away from engagement with a lumbar region of a user's spine which movement includes at least a final substantially linear reciprocal translation movement whereby during at least a portion of the movement the fifth contact areas of each pair of the opposed manipulating members move closer together as the pair of opposed manipulating members are raised;
a controller including logic arranged to perform the following steps:—
(a) to receive a signal to indicate that a user is lying on the bed area with the movable leg support in the elevated position;
(b) to perform an initial user adaption phase wherein the manipulating members are raised by generally moving predominantly unidirectionally from a rest condition to protrude further from the bed area comprising:—
a. controlling the first set of actuators to move the manipulating members of the first manipulating assembly into contact with the cervical region of a user's spine with a contact pressure within a first contact pressure range;
b. controlling the second set of actuators to move the manipulating members of the second manipulating assembly into contact with a user's shoulder blade area with a contact pressure within a second contact pressure range;
c. controlling the third set of actuators to move the manipulating members of the third manipulating assembly into contact with the thoracic region of a user's spine with a contact pressure within a third contact pressure range;
d. controlling the fourth set of actuators to move the manipulating members of the fourth manipulating assembly into contact with the thoracic region of a user's spine with a contact pressure within a fourth contact pressure range;
e. controlling the fifth set of actuators to move the manipulating members of the fifth manipulating assembly into contact with the lumbar region of a user's spine with a contact pressure within a fifth contact pressure range;
(c) to select a massage routine based on stored massage routines and optionally user input and/or sensed data during the adaptation phase;
(d) to control the actuators of each of the sets of actuators to carry out the massage routine based on generally reciprocal motion;
(e) to return the actuators to a rest condition following termination of a session of one or more massage routines, wherein
the controller is arranged to control the pairs of opposed manipulating members within each of the fourth manipulating assembly and the fifth manipulating assembly to move independently to create differential pressure within each respective spine area of a user, and wherein the controller is arranged to monitor and adjust the contact pressures in the first to fifth contact pressure ranges applied by the manipulating members.

33. A spinal massage device as claimed in claim 32, wherein the controller is arranged to disable and/or enable one or more pairs of opposed manipulating members selectively.

34. A spinal massage device as claimed in claim 32, wherein the fifth contact area is larger than any or all of the second to fourth contact areas and/or wherein the first contact area is larger than any or all of the second to fourth contact areas.

35. A spinal massage device as claimed in claim 32, wherein the first manipulating assembly comprises one first pair of manipulating members, the second manipulating assembly comprises two second pairs of manipulating members, the third manipulating assembly comprises two third pairs of manipulating members, the fourth manipulating assembly comprises four fourth pairs of manipulating members, and the fifth manipulating assembly comprises four fifth pairs of manipulating members.

36. A spinal massage device as claimed in claim 32, wherein the second manipulating assembly comprises first, second, third and fourth manipulating members, wherein one second pair of opposed manipulating member comprises the first and third manipulating members and another second pair of opposed manipulating member comprises the second and fourth manipulating members; and wherein the first and second manipulating members are coupled at or adjacent their respective second contact areas and the third and fourth manipulating members are coupled at or adjacent their respective second contact areas.

37. A spinal massage device as claimed in claim 32, wherein the movement of each second contact area as the opposed manipulating members are raised includes movement in a direction away from a vertical plane extending through the longitudinal axis of the bed area.

38. A spinal massage device as claimed in claim 32, wherein one or more of the manipulating assemblies includes at least one bracket for supporting the manipulating members, the or each bracket having:
a trunk portion supporting a first arm and a second arm; wherein
the first arm receives one manipulating member of a pair of opposed manipulating members, and the second arm receives the other manipulating member of the pair of opposed manipulating members.

39. A spinal massage device as claimed in claim 38, wherein the first manipulating assembly includes the bracket and the first arm receives one manipulating member of the first pair of opposed manipulating members, and the second arm receives the other manipulating member of the first pair of opposed manipulating members, wherein the manipulating members are supported by the arms of the bracket at an angle which is inclined away from the vertical direction and is inclined towards the head support area.

40. A spinal massage device as claimed in claim 32, wherein the controller is arranged to control the movement of the movable leg support whereby during at least a portion of the movement the movable leg support moves at a nonconstant speed.

41. A spinal massage device as claimed in claim 32, wherein the movable leg support has a leg support actuator configured to move the movable leg support progressively controllably into a raised position or a lowered position and wherein the controller is arranged to control the movable leg support via the leg support actuator.

42. A spinal massage device as claimed in claim 32, wherein the controller is arranged to store initial massage positions or approximate initial massage positions of one or more of the manipulating members for a user.

43. A spinal massage device as claimed in claim 32, wherein the controller is arranged to learn changes in force or pressure from the different sets of actuators and to adapt a stored massage routine.

44. A method of controlling a spinal massage device according to claim 32, the method comprising:
determining control signals for controlling a plurality of the manipulating members of the spinal massage device based on a stored massage routine;
applying the control signals to drive the manipulating members in at least one cycle to implement a massage routine;
receiving feedback signals from a plurality of sensors indicative of at least one of pressure and movement applied by the plurality of manipulating members during the at least one cycle; and
determining adjusted control signals based on the control signals of the stored massage routine and the received feedback signals to implement an updated massage routine.

45. A spinal massage device for a user having a plurality of actuators arranged to apply force to a user lying on the spinal massage device via a plurality of manipulating members, the actuators each having a respective motor, the device comprising a controller arranged to determine a measure of force applied by an actuator based on a measure of current drawn by the actuator and having a control algorithm for applying force sequentially to different manipulating members, the controller being further arranged to store data relating to a massage routine for a user, the controller having memory for storing an initial set of calibration parameters for use in determining a measure of force based on a measure of current applied to the motor, the controller having an adaptation module for monitoring changes in applied current for given movements for a given user over a series of at least three massage routines and for determining a change in one or more calibration parameters in response to variation of current over time associated with a given movement.

46. A spinal massage device as claimed in claim 45, wherein a measure of force is obtained based on the current drawn by an actuator and/or by a force sensor or pressure sensor or strain gauge, and/or wherein the measure of force is quasi continuous or quantised into a number of threshold ranges

47. A spinal massage device as claimed in claim 45, wherein the adaptation module is configured to take the amplitude of motion of a manipulating member as a parameter and to determine changes in the variation of current with the amplitude over time.

48. A spinal massage device as claimed in claim 45, further comprising a user adaptation module arranged to determine a change in user characteristics over a series of massage routines and to adjust or provide an option to adjust one or more parameters of the massage routine.

49. A method of controlling a spinal massage device according to claim 45, the method comprising:
determining control signals for controlling a plurality of the manipulating members of the spinal massage device based on a stored massage routine;
applying the control signals to drive the manipulating members in at least one cycle to implement a massage routine;
receiving feedback signals from a plurality of sensors indicative of at least one of pressure and movement applied by the plurality of manipulating members during the at least one cycle; and
determining adjusted control signals based on the control signals of the stored massage routine and the received feedback signals to implement an updated massage routine.

50. The method of claim 49, wherein the adjusted control signals are determined using machine learning algorithms.

51. The method of claim 49, further comprising storing a new massage routine based on the updated massage routine.
